(19) United States
(12) Patent Application Publication
(10) Pub. No.: US 2007/0101394 A1
(43) Pub. Date: May 3, 2007

(54) Indexing a recording of audiovisual content to enable rich navigation

(75) Inventors: Sai-Wai Fu, Los Altos Hills, CA (US); Brett M. Keating, San Jose, CA (US); Sundar R. Vedula, Sunnyvale, CA (US); Kevin A. Wilson, Palo Alto, CA (US); Subutai Ahmad, Palo Alto, CA (US)

Correspondence Address: David R. Graham, 1337 Chewpon Avenue, Milpitas, CA, 95035, US

(73) Assignee: YesVideo, Inc.

(21) Appl. No.: 11/282,318

(22) Filed: Nov. 19, 2005

Related U.S. Application Data
(63) Continuation-in-part of application No. 11/268,751, filed on Nov. 1, 2005.
(63) Continuation-in-part of application No. 11/268,778, filed on Nov. 1, 2005.

(51) Int. Cl. H04N 7/16; H04N 7/173

(52) U.S. Cl. 725/134; 725/142; 725/89

(57) ABSTRACT

The invention indexes an audiovisual recording to enable navigation within the audiovisual recording. In particular, the invention provides indexing within a “show” of a recording of an audiovisual broadcast (e.g., a television broadcast or a radio/satellite audio broadcast) that enables navigation within the show, in contrast to indexing among shows (i.e., identification of locations corresponding to the start and/or end of shows) that can enable navigation between shows. The invention also enables navigation among one or more intelligently selected segments of the recording in a non-linear manner. A graphical user interface can be implemented to effect navigation in accordance with the invention of a recording of audiovisual content.

### BACKGROUND OF THE INVENTION

1. Field of the Invention

This invention relates to indexing a recording of audiovisual content and, in particular, to indexing a recording of a show of audiovisual broadcast content to enable navigation within the show.

2. Related Art

Broadcast content is often divided into shows. Herein, a “show” is a self-contained section of broadcast data, with some cohesive element tying the portion of the broadcast together, and/or bounded by related introductory and closing segments. For instance, a situation comedy will feature the same actors throughout (providing cohesiveness), begin with an intro jingle, and end with closing credits. A football game can be considered a “show,” as it features the same teams and sportscasters throughout the length of that portion of the broadcast, but may or may not be bounded by introductory and closing segments. Commercials or other interruptions may or may not be considered part of the show; they are optional.

An electronic program guide (EPG) enables on-screen display of the time segmentation of shows within a broadcast. Each item displayed on an EPG display represents one show. Therefore, one may think of a “show” as the segment of a broadcast that is represented by one item in an EPG display, or by one item in any EPG-based data stream.

An EPG can enable navigation among shows of a broadcast. However, an EPG does not enable navigation within a show of a broadcast. It is desirable to have the capability for such navigation.

Additionally, previous graphical user interfaces (GUIs) for enabling interaction with audiovisual content have enabled only conventional interaction with audiovisual content, such as playback, pausing, fast-forwarding, rewinding, stepping or slow motion, and stopping. The common denominator of these ways of interacting with audiovisual content is the linear playback of the audiovisual content. It is desirable to enable interaction with audiovisual content that is not restricted to such linear playback and that provides a richer interaction with the audiovisual content.

### SUMMARY OF THE INVENTION

The invention indexes an audiovisual recording to enable navigation within the audiovisual recording. In particular, the invention provides indexing within a “show” of a recording of audiovisual broadcast (e.g., a television broadcast or a radio/satellite audio broadcast) that enables navigation within the show, in contrast to indexing among shows (i.e., identification of locations corresponding to the start and/or end of shows) that can enable navigation between shows. The invention also enables navigation of an audiovisual recording that provides increased flexibility and a richer experience than that provided by previous capabilities for navigating a recording of audiovisual content. In particular, the invention can be implemented to select indices in the recording that enable navigation among one or more intelligently selected segments of the recording in a non-linear manner. A graphical user interface can be implemented to effect navigation in accordance with the invention of a recording of audiovisual content. As appropriate, each of the aspects of the invention can be implemented as a method (or part of a method) in accordance with the description of the invention herein, a system or apparatus (or part of a system or apparatus) in accordance with the description of the invention herein (including a system or apparatus, or part thereof, that enables performance of a method or part of a method in accordance with the invention), and/or one or more computer programs and/or data structures (or part of one or more computer programs and/or data structures) including instructions and/or data for performing, or enabling performance of, a method or part of a method in accordance with the description of the invention herein.

According to one aspect of the invention, one or more segment definition indices that identify one or more segments of an audiovisual recording are provided together with graphical user interface (GUI) metadata for use in producing a graphical user interface that enables navigation of the audiovisual recording using the segment definition indices. At least one of the segments is a subset of, but not coincident with, a show of the audiovisual recording; thus, the segment identification indic(es) enable navigation within the show. The content of the GUI metadata depends on the segment identification indic(es) and/or content of the audiovisual recording. The segment identification indic(es) and GUI metadata can be provided via a communications network, e.g., a television network or a computer network. Additionally, data identifying a type of the segment identification indic(es) and/or content of the audiovisual recording can be provided via the communications network. The GUI metadata can include a GUI template or an identification of a GUI template (GUI template ID). The GUI template can be identified based on a determination of a type of the audiovisual recording, which can be ascertained from broadcast information or from an electronic program guide. The GUI template or GUI template ID can also be provided via the communications network.

According to another aspect of the invention, one or more segment definition indices that identify one or more segments of an audiovisual recording are received via a communications network and archived on a portable data storage apparatus. The archival can be in a format compatible with the portable data storage apparatus. At least one of the segments is a subset of, but not coincident with, a show of the audiovisual recording; thus, the segment identification indic(es) enable navigation within the show. The audiovisual recording can also be archived on the portable data storage apparatus, which, again, can be in a format compatible with the portable data storage apparatus. The portable data storage apparatus can be, for example, one or more DVDs.

According to still another aspect of the invention, one or more segment definition indices that identify one or more segments of an audiovisual recording, and graphical user interface (GUI) metadata for use in producing a graphical user interface that enables navigation of the audiovisual recording using the segment definition indices are archived together on a portable data storage apparatus. The archival can be in a format compatible with the portable data storage apparatus. At least one of the segments is a subset of, but not coincident with, a show of the audiovisual recording; thus, the segment identification indic(es) enable navigation within the show. The audiovisual recording can also be archived on the portable data storage apparatus, which, again, can be in a format compatible with the portable data storage apparatus. The portable data storage apparatus can be, for example, one or more DVDs.

According to still another aspect of the invention, one or more segment definition indices that identify one or more segments of an audiovisual recording, where at least one of the segments is a subset of, but not coincident with, a show of the audiovisual recording (thus enabling navigation within the show) can be used to identify one or more parts of the show to archive on a portable data storage apparatus. The archival can be in a format compatible with the portable data storage apparatus. The audiovisual recording and/or the segment identification indic(es) can also be archived on the portable data storage apparatus, which, again, can be in a format compatible with the portable data storage apparatus. The portable data storage apparatus can be, for example, one or more DVDs.

According to still another aspect of the invention, one or more segment definition indices that identify one or more segments of an audiovisual recording are provided together with digital rights management (DRM) metadata for use in controlling access to the audiovisual recording and/or auxiliary content that may be displayed in conjunction with the audiovisual recording. At least one of the segments is a subset of, but not coincident with, a show of the audiovisual recording; thus, the segment identification indic(es) enable navigation within the show. The DRM metadata controls access to at least one summary including one or more segments that are a subset of, but not coincident with, a show of the audiovisual recording; thus, DRM within a show is enabled. The DRM metadata can specify one or more advertisements that must be displayed before display of a summary or specified auxiliary content is allowed.

According to still another aspect of the invention, the content of an audiovisual recording is evaluated to identify one or more segment definition indices that identify one or more segments of an audiovisual recording, where at least one of the segments is a subset of, but not coincident with, a show of the audiovisual recording (thus enabling navigation within the show), and the segment definition indic(es) correspond to locations in the audiovisual recording other than locations corresponding to a transition or film edit. Navigation within the show is enabled in response to an input received from an observer and based on the segment identification indic(es).

According to still other aspects of the invention, one or more segment definition indices that identify one or more segments of an audiovisual recording, where at least one of the segments is a subset of, but not coincident with, a show of the audiovisual recording (thus enabling navigation within the show) are identified or modified in response to input from an observer during display of the audiovisual recording. Navigation within the show is enabled based on the segment identification indic(es).

### BRIEF DESCRIPTION OF THE DRAWINGS

FIG. 1 is a block diagram of a system, according to an embodiment of the invention, that enables navigation within a show of an audiovisual broadcast.

FIG. 2 is a simplified diagram of a system, according to an embodiment of the invention, that enables navigation within a show of a television broadcast.

FIGS. 3A through 3C illustrate a set of generic menu displays, according to an embodiment of the invention, that enable navigation of an audiovisual recording in accordance with the invention.

FIG. 4 illustrates a data structure, according to an embodiment of the invention, that can be used in specifying metadata concerning DRM and a GUI that is included as part of DPG data.

FIGS. 5A through 5D illustrate a set of menu displays, according to an embodiment of the invention, that enable navigation of a recording of a football game in accordance with the invention.

### DETAILED DESCRIPTION OF THE INVENTION

### I. Overview of Invention and Advantages

In accordance with the invention, a recording of audiovisual content is indexed (i.e., one or more locations within the recording is identified) to enable navigation within the audiovisual recording. As explained further below, the invention enables navigation within audiovisual content at a finer level of granularity than has previously been enabled: the invention is sometimes referred to herein as a “Deep Program Guide” (or “DPG”) to indicate this more refined (“deeper”) capability of navigating a recording of audiovisual content. In particular, the invention provides indexing within a show that enables navigation within a show, in contrast to indexing among shows (i.e., identification of locations corresponding to the start and/or end of shows) that can enable navigation between shows. An EPG segments shows from one another; a DPG according to the invention segments parts of a show from other parts of that show. further, as will be appreciated from the description of the invention below, indexing a recording of audiovisual content in accordance with the invention enables navigation of the recording that provides increased flexibility and a richer experience to an observer of the recording (who, depending on the nature of the recording, may be a viewer and/or a listener) than that provided by previous capabilities for navigating a recording of audiovisual content. In particular, the invention can be implemented to select indices in the recording so that an observer can navigate among one or more intelligently selected segments of the recording in a non-linear manner. A graphical user interface (GUI) can be implemented to effect navigation in accordance with the invention of a recording of audiovisual content. The interaction functionality enabled by the GUI can be dependent upon the audiovisual content being indexed, the indexing of the audiovisual content, and upon the data and functionality offered by the particular manner of audiovisual content indexing. Aspects of the invention can particularly advantageously be used with widely available audiovisual content, such as broadcast content: for example, the invention can advantageously be used to enable navigation within a recording of a television broadcast or a radio/satellite audio broadcast. As appropriate, each of the aspects of the invention can be implemented as a method (or part of a method) in accordance with the description of the invention herein, a system or apparatus (or part of a system or apparatus) in accordance with the description of the invention herein (including a system or apparatus, or part thereof, that enables performance of a method or part of a method in accordance with the invention), and/or one or more computer programs and/or data structures (or part of one or more computer programs and/or data structures) including instructions and/or data for performing, or enabling performance of, a method or part of a method in accordance with the description of the invention herein.

For example, as described in more detail below, the invention can be implemented to select indices in a recording of a sporting event that define segments corresponding to parts of the sporting event that are deemed particularly meaningful parts of the sporting event. For instance, indices can be selected in a recording of a football game that define segments corresponding to the plays of the football game. More particularly, indices can be selected in a recording of a football game that define segments corresponding to plays having particular characteristic(s), such as plays of a particular type (e.g., touchdowns, field goals, passing plays, running plays, fumbles, interceptions, sacks, penalties, punt or kickoff returns) or plays featuring action by a particular player (e.g., passes by a quarterback; runs by a running back; receptions by a receiver; interceptions, sacks or fumble recoveries by a defensive player; returns by a punt or kickoff returner). As any football fan knows, much of the duration of a recording of a football game corresponds to time between plays of the game, which may include content (e.g., replays, footage of the crowd, etc.) of less interest to an observer of the recording. Consequently, the capability of navigating among the plays of a recording of a football game can be particularly desirable for an observer of the recording.

Or, for example, as also described in more detail below, the invention can be implemented to enable an observer of a recording to specify indices for that recording. In general, it can be assumed that the observer will specify indices that define segments corresponding to audiovisual content that is of particular interest, either specifically to the observer or (in the observer's estimation) to a general audience. Consequently, the capability of navigating among the segments of a recording identified by an observer (the “indexing observer”) of the recording may be of particular interest to another observer, especially if that observer knows the indexing observer (which may incline that observer to observe or avoid the identified segments).

The invention can be used with recordings of audio content, visual content, or a combination of audio and visual content. Further, the audiovisual content with which the invention is concerned is content that occurs over one or more periods of time. Thus, visual content includes one or more series of visual images, each series of visual images typically acquired at a regular interval by a visual image data acquisition apparatus such as a video camera. Similarly, audio content includes one or more series of audio samples, each series of audio samples typically acquired at a regular interval by an audio data acquisition apparatus, which can also be a video camera. To make description of the invention less cumbersome, “audiovisual content” is used herein to refer to visual and/or audio content,” though, as used herein, “audiovisual content” may not include visual content or may not include audio content. It is anticipated, however, that recordings of audiovisual content—often shortened herein to “audiovisual recording”—with which the invention is used will often include both visual and audio content. For example, the invention can advantageously be used to enable navigation within television broadcast content. When, as will typically be the case, the audiovisual recording includes both visual and audio content, the visual recording data and audio recording data are typically synchronized so that audio recording data corresponding to the visual recording data of a navigational index or segment (e.g., summary) can be extracted from the audiovisual recording for use in display of that navigational index or segment.

Implementation of the invention to enable navigation within an audiovisual recording using video frames is described. However, the invention can readily be implemented to make use of audio samples in enabling navigation of an audiovisual recording: in that case, audio frames including one or more audio samples can be defined and used instead of frames of video.

The invention can be used with audiovisual recording data represented in analog or digital form. However, if represented in analog form, the audiovisual recording data must be converted to digital form prior to use of the invention with respect to that audiovisual recording. Further, in general, audiovisual recording data can be stored on any data storage medium or media, including analog and/or digital data storage media. However, even when all of an audiovisual recording is initially stored on analog data storage medi(a), the audiovisual recording data must at some point be stored on digital data storage medi(a) since the audiovisual recording data must be converted to digital form to enable processing in accordance with invention.

One or more aspects of the invention can be implemented, in whole or in part, by one or more computer programs (i.e., any set of instructions and/or data that can be used by computational apparatus to effect operation of a method or part of a method) and/or data structures, or as part of one or more computer programs and/or data structure(s), including instruction(s) and/or data for accomplishing the functions of the invention. (For convenience, “computer code” is sometimes used herein to refer to instruction(s) and/or data that are part of one or more computer programs.) The one or more computer programs and/or data structures can be implemented using software and/or firmware that is stored and operates on, and effects use of, appropriate hardware (e.g., processor, volatile data storage apparatus such as a memory, non-volatile data storage apparatus such as a hard disk). Those skilled in the art can readily implement aspects of the invention using one or more computer program(s) and/or data structure(s) in view of the description herein. Further, those skilled in the art can readily appreciate how to implement such computer program(s) and/or data structure(s) to enable execution and/or storage on any of a variety of computational apparatus and/or data storage apparatus, and/or using any of a variety of computational platforms.

In general, the invention can be implemented using any type of apparatus (which can include one or more devices) having appropriate computational capability, data storage capability, audiovisual display capability, audiovisual data reception capability, and/or data communications capability to effect the functions of the invention. As can be appreciated from the description herein, the invention can readily be implemented, in whole or in part, using apparatus adapted to obtain, store and/or play back digital audiovisual recordings; however, the invention can also be implemented, in whole or in part, using apparatus adapted to obtain, store and/or play back analog audiovisual recordings if the apparatus has—or can make use of other apparatus which has—the capability of converting the analog audiovisual recording to digital form to enable processing of the recording in accordance with invention.

### II. DPG Systems

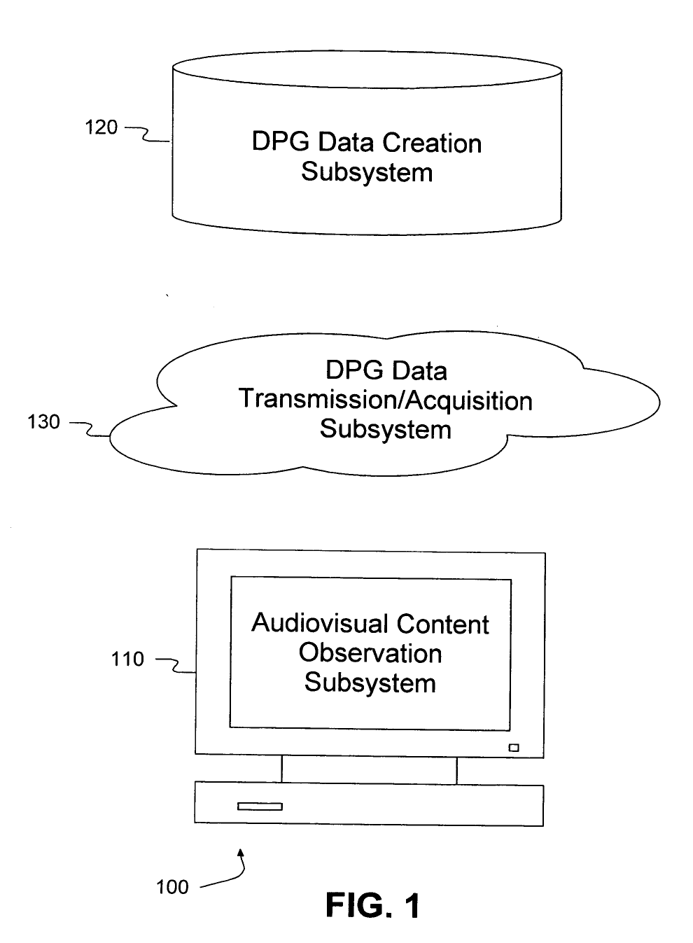

FIG. 1 is a block diagram of a system 100, according to an embodiment of the invention. The system 100 includes audiovisual content observation subsystem 110, DPG data creation subsystem 120 and DPG data transmission/acquisition subsystem 130. Components of the system 100 can be implemented in the same apparatus as that in which other component(s) of the system 100 are implemented, or in apparatus that is physically separate from any other apparatus in which another component of the system 100 is implemented. Depending on the implementation of the invention, the DPG data creation subsystem 120 may be present at the same or a different location as that at which the audiovisual content observation subsystem 110 is located. In the former case, the DPG data transmission/acquisition subsystem 130 is also present at that location. In the latter case, the DPG data transmission/acquisition subsystem 130 is distributed between the two locations.

The audiovisual content observation subsystem 110 includes an audiovisual recording display and an audiovisual display user interface. The audiovisual recording display enables display of an audiovisual recording and can be implemented by, for example, any type of television or any type of display device for use with computational apparatus (e.g., a conventional computer display monitor). The audiovisual display user interface enables control of the display of the audiovisual recording on the audiovisual recording display (and, in particular, enables navigation of the audiovisual recording using DPG data) and can be implemented by, for example, conventionally constructed user interface apparatus associated with the audiovisual recording display, such as a remote control device or control mechanisms (pushbuttons, toggle switches, etc.) that are part of the audiovisual recording display. As can readily be appreciated, the audiovisual display user interface is implemented to include the capability of navigating the audiovisual recording based on DPG data. (Apparatus that can be used to interact with an audiovisual recording using DPG data is sometimes referred to herein as DPG-enabled apparatus.) It is anticipated that the audiovisual recording display and audiovisual display user interface will often be implemented together in a television (which may additionally include a remote control device for particular use in implementing the audiovisual display user interface) or television system (which may include other apparatus in addition to a television, e.g., a hard-drive based digital video recorder such as a personal video recorder (PVR), a DVD recorder or other digital video recorder, a DVD player, a VCR, and/or a set-top box with or without hard drive). The audiovisual content observation subsystem 110 can also be implemented by, for example, a radio-frequency receiver and associated audio display apparatus, any type of computer (e.g., a computer characterized as a personal computer, desktop computer, server computer, laptop computer, or mainframe computer), a cellular phone with audiovisual capabilities and memory or hard disk storage, or other similar handheld devices (e.g., a personal digital assistant, a personal media recorder or player, such as, for example, the Zen Portable Media Center produced by Creative Labs, Inc. of Milpitas, Calif., or the Pocket Video Recorder made by Archos, Inc. of Irvine, Calif.). As can be seen, the audiovisual content observation subsystem 110 can be implemented, in whole or in part, on (i.e., as part of, or together with) apparatus which has a primary purpose of recording and/or playing back an audiovisual recording (e.g., television, radio, DVD player, DVD or other digital video recorder; PVR or other hard-drive-based video recorder, VCR, set-top box, personal media recorder or player), and/or on other apparatus (e.g., computer, cellular phone or other handheld device, personal digital assistant). The audiovisual content observation subsystem 110 also includes apparatus enabling reception of DPG data, such as conventional apparatus adapted to enable communications over a communications network (examples of which are described below) or conventional apparatus adapted to enable access to audiovisual recording data on portable data storage medi(a), such as appropriate drives (disk drives, DVD drives, CD drives, USB drives, flash card drives) having read capabilities or other mechanisms for communicating data to a computer or other data storage apparatus, such as a USB port, a parallel interface, a serial interface or infrared transmission receiver.

The DPG data creation subsystem 120 enables creation of DPG data for an audiovisual recording. The DPG data creation subsystem 120 can be implemented by apparatus that enables automatic creation of DPG data, i.e., apparatus adapted to evaluate audiovisual recording data (and/or associated data, such as closed-caption data and electronic program guide data) to identify DPG data for that audiovisual recording (which includes at least computational apparatus for performing the evaluation and may include other apparatus that enables and/or facilitates the evaluation, such as apparatus for acquiring audiovisual recording data). Additionally or alternatively, the DPG data creation subsystem 120 can be implemented by apparatus that enables manual creation of DPG data, e.g., apparatus adapted to enable a person observing an audiovisual recording to specify DPG data as the audiovisual recording is displayed (which includes at least user interface apparatus for specifying an index—e.g., a remote control device or control mechanisms such as pushbuttons that are part of audiovisual recording display or user interface apparatus—and may include other apparatus for enabling and/or facilitating such specification, such as apparatus for acquiring audiovisual recording data and/or apparatus for controlling display of the audiovisual recording). In either case, the DPG data creation subsystem 120 can be present at the same or a different location as that at which the audiovisual content observation subsystem 110 is located. The DPG data creation subsystem 120 can be implemented using, for example, any of the following apparatus: a television receiver or radio-frequency receiver, a hard-drive based digital video recorder such as a personal video recorder (PVR), a DVD recorder or other digital video recorder, a DVD player, a VCR, a set-top box with or without hard drive), any type of computer (e.g., a computer characterized as a personal computer, desktop computer, server computer, laptop computer, or mainframe computer), a cellular phone with audiovisual capabilities and memory or hard disk storage, or other similar handheld devices (e.g., a personal digital assistant, a personal media recorder or player, such as, for example, the Zen Portable Media Center produced by Creative Labs, Inc. of Milpitas, Calif., or the Pocket Video Recorder made by Archos, Inc. of Irvine, Calif.). Like the audiovisual content observation subsystem 110, the DPG data creation subsystem 120 can be implemented, in whole or in part, on (i.e., as part of, or together with) apparatus which has a primary purpose of recording and/or playing back an audiovisual recording (e.g., television, radio, DVD player, DVD or other digital video recorder; PVR or other hard-drive-based video recorder, VCR, set-top box, personal media recorder or player), and/or on other apparatus (e.g., computer, cellular phone or other handheld device, personal digital assistant). The DPG data creation subsystem 120 also includes apparatus enabling transmission of DPG data, such as conventional apparatus adapted to enable communications over a communications network (examples of which are described below) or conventional apparatus adapted to enable storage of audiovisual recording data on portable data storage medi(a), such as appropriate drives (disk drives, DVD drives, CD drives, USB drives, flash card drives) having write capabilities or other mechanisms for communicating data from a computer or other data storage apparatus, such as a USB port, a parallel interface, a serial interface or infrared transmitter.

The DPG data transmission/acquisition subsystem 130 enables DPG data to be obtained for use by audiovisual content observation subsystem 110 in enabling navigation of an audiovisual recording. The particular manner of implementing the DPG data transmission/acquisition subsystem 130 can depend on whether the DPG data creation subsystem 120 is implemented at the same or a different location as that at which the audiovisual content observation subsystem 110 is located. For example, if the DPG data creation subsystem 120 is implemented in the same apparatus or system of apparatus as that in which the audiovisual content observation subsystem 110 is implemented, the DPG data transmission/acquisition subsystem 130 may be implemented as a communications bus in or between such apparatus that enables communication of the DPG data from the DPG data creation subsystem 120 to the audiovisual content observation subsystem 110 for use in navigating the audiovisual recording. If the DPG data creation subsystem 120 is present at a different location than that at which audiovisual content observation subsystem 110 is located (i.e., the DPG data creation subsystem 120 is at a remote location), the DPG data transmission/acquisition subsystem 130 can be implemented, for example, by apparatus adapted to send DPG data via a communications network (e.g., a computer network such as the Internet, a television network, or a telephone network including a conventional and/or cellular telephone network), such as conventional apparatus for sending data via a network of that type, and apparatus adapted to receive DPG data via the communications network, such as a PVR, DVD recorder or set-top box having such network communications capability. Or, when the DPG data creation subsystem 120 is at a remote location, the DPG data transmission/acquisition subsystem 130 can be implemented by apparatus adapted to store DPG data on a portable data storage medium (a large variety of which are known and can be used with the invention, such as a DVD or CD drive with write capabilities, and apparatus adapted to read data stored on the portable data storage medium (which can have been sent from the remote location by mail or a delivery service), such as a DVD or CD player. When the DPG data creation subsystem 120 is at a remote location, DPG data can be sent to an audiovisual content observation subsystem 110 in response to a request from the audiovisual content observation subsystem 110, or DPG data can be sent automatically without such request (e.g., DPG data may be provided by subscription, for example).

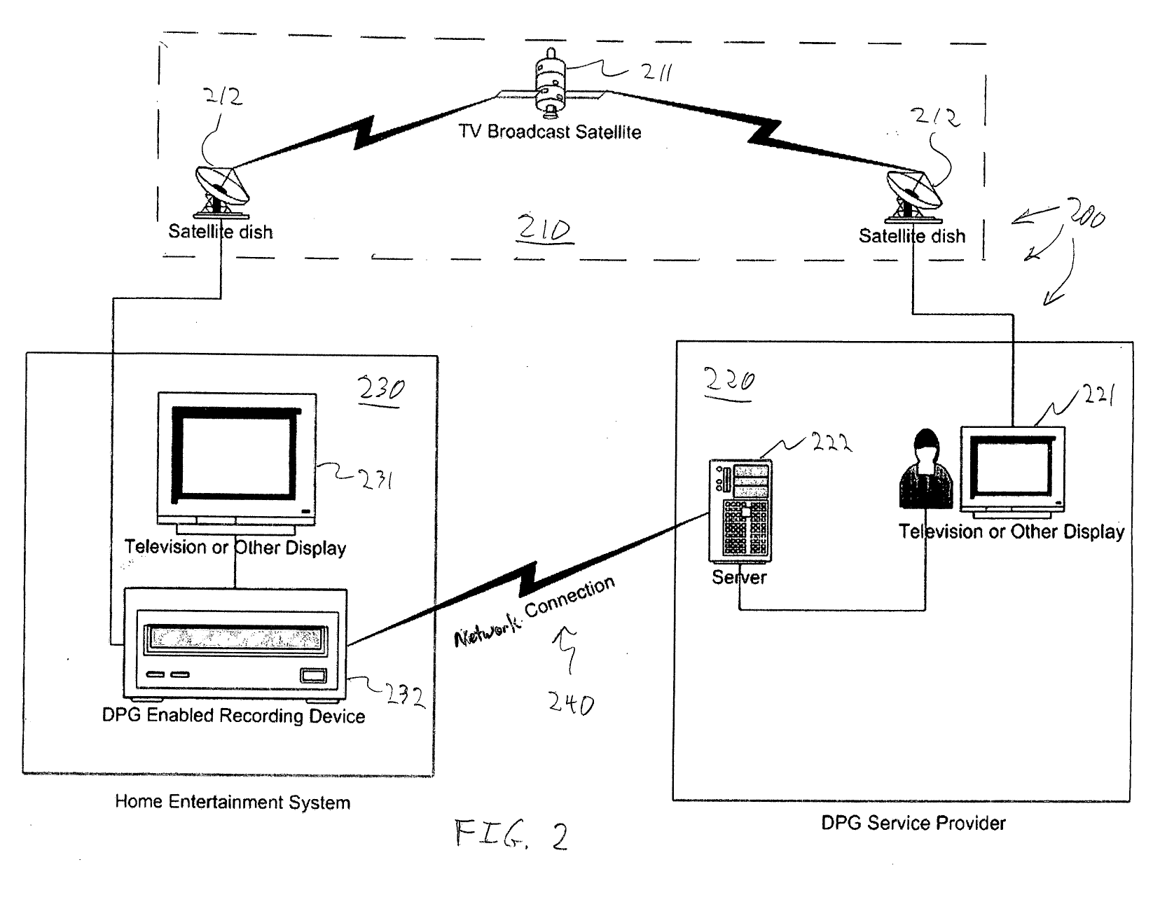

FIG. 2 is a simplified diagram of a system 200, according to an embodiment of the invention. The system 200 includes a television broadcast system 210, a DPG data service provider system 220 and an audiovisual content observation system 230. (In practice, there are typically many audiovisual content observation systems 230; for simplicity, only one is illustrated in FIG. 2. Similarly, there can be multiple DPG data service provider systems 220; however, again, for simplicity, only one is illustrated in FIG. 2.)

In general, the television broadcast system 210 can be implemented using any conventional methods and apparatus for effecting broadcast of television content, as are well known to those skilled in the art. As illustrated in FIG. 2 in simplified form, a television broadcast satellite 211 transmits television content that can be received by each of a multiplicity of satellite dishes 212. (In practice, there are typically many satellite dishes 212; for simplicity, only two are illustrated in FIG. 2.) In turn, the television content is transmitted from the satellite dishes 212 to a multiplicity of apparatus adapted to enable reception and display of television content.

The DPG data service provider system 220 includes television content reception apparatus 221 and DPG data server 222. The television content reception apparatus 221 can be implemented using any of a variety of conventional methods and apparatus, as are well known to those skilled in the art. In particular, the television content reception apparatus apparatus 221 includes data storage apparatus for storing data representing television broadcast content or is adapted to communicate such data to a data storage apparatus that is also part of the DPG data service provider system 220. As described in more detail below, DPG data can be produced at the DPG data service provider system 220, either automatically or manually, for at least some of the television broadcast content. The DPG data is communicated to the DPG data server 222 (or the DPG data may already by stored by the DPG data server 222 if, for example, the data representing television broadcast content was stored at the DPG data server 222 and the DPG data determined automatically by the DPG data server 222) to enable DPG data to be communicated to audiovisual content observation systems 230 in accordance with requests received by the DPG data server 222 for DPG data.

As illustrated in FIG. 2, the DPG data server 222 communicates with the audiovisual content observation system 230 via a communications network 240. Such communication can include, for example, requests for DPG data sent by audiovisual content observation system 230 to DPG data server 222 and DPG data sent by the DPG data server 222 to the audiovisual content observation system 230. The communications network 240 can be implemented using any desired type of network (e.g., the Internet or other network conventionally thought of as a computer network; a cable television network; a satellite television network; a fiber-optic network; a telephone network, including a wired and/or wireless telephone network; Bluetooth network; Wi-Fi network, or some combination of the foregoing) using any of a variety of conventional methods and apparatus, as are well known to those skilled in the art. Alternatively, communication between the DPG data server 222 and audiovisual content observation system 230 can be effected other than by using a communications network. For example, DPG data and requests for DPG data can be stored on a portable data storage medium and transmitted by mail or delivery service.

The audiovisual content observation system 230 includes television 231 and audiovisual recording recorder 232. The television 231 can be implemented by any of a wide variety of televisions, as are commonly known. The audiovisual recording recorder 232 is adapted to receive and store data representing television broadcast content. The audiovisual recording recorder 232 is also adapted to transmit and store data received via communications network 240. In particular, the audiovisual recording recorder 232 can send requests for DPG data to a DPG data server 222 and receive DPG data from the DPG data server 222. The audiovisual recording recorder 232 can be implemented by, for example, a PVR, DVD recorder or set-top box that is adapted to communicate via communications network 240.

### III. Navigation Using DPG Data

The invention enables navigation within a recording of audiovisual content at a finer level of granularity than has previously been enabled (e.g., navigation within a “show”). Such navigation is enabled by the DPG data, as discussed above and in more detail below. For an audiovisual recording for which DPG data exists, the capability of effecting navigation based on the DPG data can be presented to an observer in any manner that enables such navigation. For example, the invention can be implemented so that, as an audiovisual recording is being observed, an observer can indicate that it is desired to navigate the audiovisual recording in the manner enabled by the invention. This can be enabled in any appropriate manner and, in particular, using an existing mechanism that is part of an existing user interface that enables interaction with audiovisual recordings (e.g., a menu of an EPG can include a menu choice that enables navigation of an audiovisual recording, in accordance with the invention, using DPG data). In response to an indication that it is desired to navigate the audiovisual recording using DPG data, one or more menus (or other user interface mechanisms that can provide comparable functionality) can be displayed that include menu choices enabling identification of audiovisual content or parts of audiovisual content which can be selected for observation. Each choice in a menu can cause the display of a new menu page (with a further set of menu choices), display of a part of the audiovisual recording, display of a metadata page including auxiliary content related to the content of the audiovisual recording (e.g., an additional audiovisual recording, or textual matter such as an advertisement or, if the audiovisual content display is of a sporting event, a display of statistics for a particular athlete), or display of an interactive menu page including one or more additional GUI elements that enable particular actions (e.g., a slider bar that enables editing of bookmarks or of data defining a summary of the audiovisual content, as discussed below, or a button that can be used to initiate a commercial transaction).

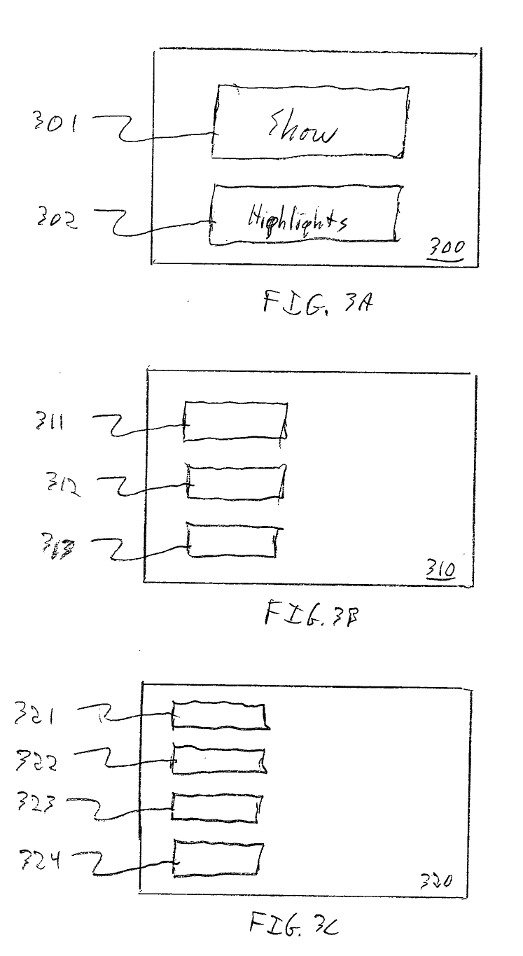

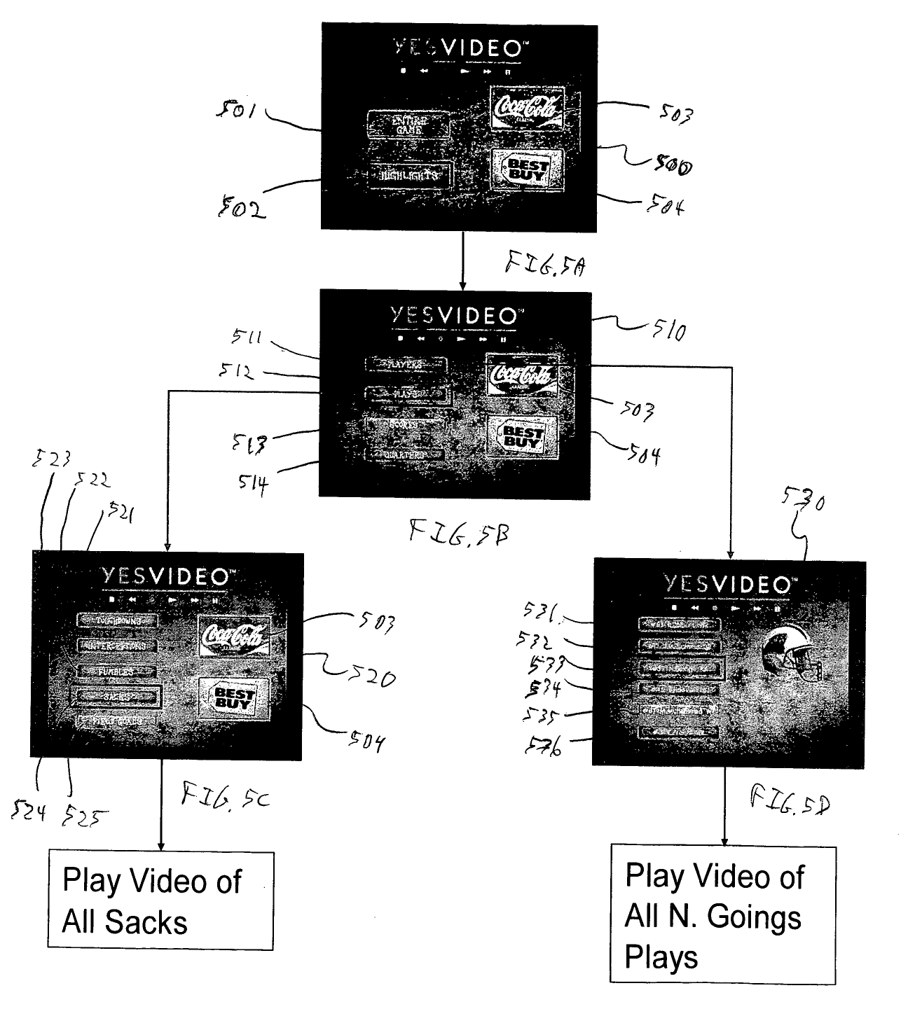

FIGS. 3A through 3C illustrate a set of generic menu displays that enable navigation in the above-described manner. (FIGS. 5A through 5D described below, illustrate a similar set of menu displays for a particular implementation of the invention.) FIG. 3A illustrates an initial menu display 300 that enables selection of the entire audiovisual recording for observation (menu choice 301) or selection of a part of the audiovisual recording for observation (menu choice 302). FIG. 3B illustrates a menu display 310 that is displayed in response to selection of menu choice 302 of the menu display 300 that indicates a desire to watch a part of the audiovisual recording. The menu display 310 includes three menu choices 311, 312 and 313, each of which identify parts of the audiovisual recording of a particular type (FIG. 5B, described below, illustrates an example of such types for an implementation of the invention in which the audiovisual recording is a recording of a football game) that can be selected for observation. FIG. 3C illustrates a menu display 320 that is displayed in response to selection of one of the menu choices 311, 312 or 313 of the menu 310. The menu display 320 includes four menu choices 321, 322, 323 and 324, each of which identify one or more parts of the audiovisual recording that will be displayed upon selection of that menu choice (FIGS. 5C and 5D, described below, illustrate examples of part(s) of a recording of a football game that can be selected for display).

FIGS. 3A through 3C illustrate the use of a hierarchical menu system to enable navigation of an audiovisual recording in accordance with the invention. In general, such a hierarchical menu system can be of arbitrary complexity, i.e., the menu system can include any number of levels and each menu can include any number of menu choices (though, typically, each menu will include two or more menu choices). Further, as indicated above, other methods of presenting parts of an audiovisual recording to an observer for possible observation can be used with embodiments of the invention.

Eventually, interaction with menu(s) results in display of a part of the audiovisual recording. As explained elsewhere herein, the part of the audiovisual recording that is displayed is a highly accurate match to a part of the audiovisual recording that was defined using another version of the audiovisual recording for which the offset relative to the version of the audiovisual recording being displayed is not known without performing an alignment of the two versions of the audiovisual recording. The invention can also be implemented to enable control of the display of part(s) of an audiovisual recording that have been selected for display in accordance with the invention, an appropriate user interface being presented to the observer to enable such control before and/or during the display of those part(s) of the audiovisual recording.

In particular, a GUI can be implemented to include an on-screen display (OSD) menu of functionality available during playback of the audiovisual recording (which may appear automatically when an audiovisual recording begins playback, or in response to input to a remote control). An OSD menu of can be rendered as, for example, a transparent menu display overlaying the display of the audiovisual recording. Alternatively, an OSD menu can be presented by resizing a window in which the audiovisual recording is displayed so that space is allotted for display of the OSD menu. An OSD menu can provide conventional user interface capabilities, such as playback, pausing, fast-forwarding, rewinding, stepping or slow motion, and stopping (see, e.g. the upper part of FIGS. 1A through 1D). An OSD menu can also be implemented so that, after selection of part(s) of an audiovisual recording for display, “next” and “previous” graphical pushbuttons (or other GUI mechanisms) are displayed that enable, respectively, skipping ahead to the beginning of a next part of the audiovisual recording that has been selected for display or skipping back to the beginning of a part of the audiovisual recording currently being displayed (or, if at the beginning of a part of the audiovisual recording, to the beginning of the part of the audiovisual recording, if any, immediately prior to the one currently being displayed).

The invention can be implemented so that functionality presented in an OSD menu is dependent upon DPG data available for that particular audiovisual recording and/or upon the content of the audiovisual recording. Thus, just as the navigational menus of a GUI, an OSD menu can be dynamic, i.e., the content of the OSD menu can be different for different audiovisual recording displays. For example, an OSD menu can be used to display alerts regarding other available audiovisual recordings (e.g., other television programming) or commerce opportunities that are related to particular audiovisual content.

However, as described below, an OSD menu can also provide unique functionality not previously provided in an OSD menu. In particular, an OSD menu can provide functionality that arises from use of the GUI with indexed audiovisual content. For example, an OSD menu can be used to select a set of one or more indices for use in producing a display of part of the audiovisual recording, select a set of one or more indices for editing, create an index in an audiovisual recording during display of that audiovisual recording and/or edit previously created indices.

For instance, as an observer begins playback, a dialog box can be presented asking the observer to select a set of indices to load for playback. In general, any number of sets of indices can be made available for selection. An observer may want to use (view and/or edit) different set of indices at different times. For example, for a recording of a football game, there may be available a set of indices created by the observer of the audiovisual recording, a set of DPG indices received from a friend, and another set of indices received from a broadcast content provider.

After a set of indices is selected and playback begins, the OSD menu can include a GUI element that enables the option of selecting a new set of indices for playback. The selection of a set of indices can also be reflected in one or more menus that present index-specific display(s). For example, one or menus can present visual previews of the content at particular indices. One or more other menus can present menus that enable editing of indices and publishing of indices, as discussed in more detail below.

In general, control of the GUI can be effected using any of a variety of apparatus, as can readily be appreciated. Operation of the GUI relies primarily on control mechanisms of a host apparatus (e.g., remote control, front panel controls, keyboard, mouse, display screen). Operation of the GUI also relies on the host apparatus interface for receiving DPG data, as well as the source for the DPG data. In a typical embodiment, the GUI can be completely controlled via a device remote control with a 4-way directional pad, a button assignable to the “bookmark” function, and a button assignable to a “next” function of the GUI. The “bookmark” button can be used in conjunction with the OSD menu and manual creation of indices during playback. The “next” button can be used to jump to a next index (i.e., a next part of the audiovisual recording), as described above.

The following illustrates the rich navigation enabled by the invention. On a television system (or other audiovisual content display apparatus, a listing of shows (e.g., an electronic program guide, or “EPG”) is presented that indicates which shows are indexed to enable rich navigation in accordance with the invention and which are not. The television system is adapted to enable communication via a communications network, e.g., a computer network such as the Internet, a television network, or a telephone network (including a conventional and/or cellular telephone network). The television system can be controlled with a remote control adapted, as explained further below, to enable navigation of the audiovisual recording display in accordance with the invention. Upon selecting a show indexed to enable rich navigation, a menu page of a menu navigation system of a GUI according to the invention is displayed that presents multiple options for interaction with the audiovisual content of the show. By selecting appropriate menu choices, an observer of the audiovisual recording display navigates to an appropriate menu page to enable download of index data for a recording of a football game via the communications network. Download of the index data enables the GUI to display themed menus specific for a recording of a football game and, further, for the teams playing this particular game. The GUI displays DRM restrictions imposed by the content owner (e.g., the NFL) in order to restrict access to particular functionality of the GUI. The observer complies with the conditions established by the DRM by, for example, entering an access code or watching an advertisement. As a consequence, the observer is allowed access to menu pages offering otherwise unavailable rich interaction with the recording, such as the ability to watch particular subsets of the game action, e.g. only particular types of plays such as interceptions or touchdowns, specific player highlights. The observer then elects to display a particular touchdown drive, and becomes interested in a certain play of the touchdown drive. The GUI provides two options for the observer to “bookmark” the play: the observer can use the remote control to set indices on screen during playback, or the observer can manually create indices using index editing tools that can be accessed using the system navigation menus. The observer then decides he would like to share these particular plays with others who have recorded this football game, so he navigates to the index publishing menu to upload his created indices to servers which make these custom indices available to a select audience, or he shares the indices in a peer-to-peer fashion. The observer then decides to display the season statistics of the star player involved in this play by instructing the GUI to present this information on screen. Now enthralled with this particular player, the observer navigates to a commerce menu of the GUI or navigates to a commerce area related to this player directly from the statistics display page, and purchases the NFL jersey of that player. Finally, the observer navigates to the recording archival menu pages and proceeds to transfer the recorded football game to DVD for future playback on this television system or other audiovisual content display apparatus (including a computer). Ways in which the invention can be implemented to enable the foregoing navigation of, and interaction with, an audiovisual recording are described in more detail elsewhere herein.

### IV. DPG Data

DPG data for an audiovisual recording must include at least data representing one or more segment definition indices for each segment of the audiovisual recording that can be selected for display. (A “segment” is a contiguous section of content in the audiovisual recording and is sometimes also referred to as a “clip.” “Segment” can also be used to refer to the data representing such a contiguous section of content in the audiovisual recording.) As discussed further below, data representing segment definition indices may be accompanied by other data regarding groups of segment indices (e.g., data representing a segment or summary label).

DPG data can include one or more other types of data. For example, DPG data can include alignment data (e.g., an alignment signature that can be used in producing an alignment or an offset function produced by an alignment) that can be used to ensure that segment definition indices created using one version of an audiovisual recording identify the same temporal locations in a second version of the audiovisual recording for which the DPG data (including the data representing the segment definition indices) is to be used in effecting navigation. DPG data can also include metadata that concerns one or more aspects of interacting with the data representing the segment definition indices, such as digital rights management and/or presentation of a graphical user interface (GUI) to enable navigation of the audiovisual recording using DPG data. Each of these types of data that can be included in the DPG data for an audiovisual recording are discussed in more detail below.

Other types of data may be associated with the DPG data. For example, data representing visual images or artwork (e.g., sports team logos) may accompany the DPG data for use in presenting a GUI. Or, data for use in producing a display of auxiliary content (e.g., additional audiovisual recording(s), text articles, advertisements, etc.) related to the content of the audiovisual recording can be provided, either with the DPG data or at a later time in response to navigation of the audiovisual recording using the DPG data.

A. Header

DPG data can include a header that specifies a variety of metadata regarding the DPG data. For example, the invention can be implemented so that the DPG data includes a header that specifies the size of the DPG data structure, the version of the DPG data, an identification of the publisher of the DPG data, and an identification of the provider of the DPG data. (The provider of DPG data is an entity from whom DPG data can be requested and obtained and a publisher of DPG data is an entity that creates DPG data. A publisher of DPG data may, but need not necessarily be, a provider of DPG data; when not, the publisher provides data to a provider who, in turn, makes the DPG data available to be obtained.)

B. Segment Definition Indices

DPG data for an audiovisual recording includes at least data representing one or more indices for each segment of the audiovisual recording that can be selected for display. Each index identifies a location in the audiovisual recording and can generally be represented by any form of timestamp that identifies that location in the audiovisual recording. For example, in the case of an audiovisual recording that includes visual content (e.g., a recording of a television broadcast program), an index can be an identification of a frame of visual recording data (e.g., identification of a video frame). In the case of an audiovisual recording that includes audio content (e.g., a recording of a television or radio broadcast program), an index can be an identification of an audio sample or an audio segment (i.e., a specified number of temporally contiguous audio samples). A segment can be identified by start and end indices that identify the beginning and end of a segment. A segment can also be identified by a single index and some way of identifying how the segment is formed using the index. For example, a segment can be defined as a specified number of frames or amount of time before and/or after an index, i.e., n frames before the index, m frames after the index, n frames before and m frames after the index, x seconds before the index, y seconds after the index, or x seconds before and y seconds after the index. Or, a segment can be defined by analyzing the audiovisual content (visual image data, audio data or both) in proximity to the index and identifying “events” that constitute the beginning and the end of the segment, e.g., a sudden increase in loudness three seconds before the index and a sudden change in color seven seconds after the segment index can be identified and the corresponding frames specified as the start frame and end frame, respectively, of the segment. Or, a segment can be defined implicitly by a single index that represents a logical break in the audiovisual recording (e.g., a DVD chapter break), the segment being the content of the audiovisual recording from the index to a next index representing a logical break in the audiovisual recording (e.g., a DVD chapter). (In the description hereinafter, for convenience, a segment is often described as a pair of indices, even though a segment may be specified by a single index, as described above. Further, discussion of specification of a start or end index can apply as well, in general and with appropriate modification, to specification of a single index that defines a segment.) Segments defined by segment identification indic(es) may overlap, i.e., one segment of the audiovisual recording that can be selected for display may include content from one or more other segments of the recording that can be selected for display.

As discussed above, the invention enables parts of an audiovisual recording to be selected for display. A part of the audiovisual recording that can be selected for display can include any number of segments (one or multiple segments) and is sometimes referred to herein as a “summary.” In one embodiment of the invention, DPG data includes a summary section that includes a list of summaries for the audiovisual recording to which the DPG data corresponds. For each summary, the indic(es) defining the segment(s) of that summary are stored. Additionally, an identifier (label) can be stored for a segment or a summary. Labels for segments can assist in the formation of summaries by facilitating grouping similar segments into the same summary. Labels can also be used in relating segment(s) (or summar(ies)) to a part of a GUI specification, e.g., a GUI element can be used to effect display of all segments having a particular identifier. Labels can also be used to select a GUI template for use in presenting a GUI. A label can indicate a type for the segment which, in some manner, represents the subject matter of the segment. For example, a segment can be identified as a commercial break, a joke, or a sports play. As can be appreciated, many other types are possible and the types will generally be chosen to suit the content of the audiovisual recording. The DPG data can also include data indicating the number of segments in the summary.

C. Alignment Signature

In many embodiments of the invention, DPG data is created using a version of an audiovisual recording (e.g., a first recording of a broadcast program) that is different from the version of the audiovisual recording (e.g., a second recording of the same broadcast program) for which the DPG data will be used in effecting navigation. (To simplify description of this aspect of the invention, the version of the audiovisual recording used to create the DPG data is sometimes referred to in this section as the “master version” of the audiovisual recording and the version of the audiovisual recording for which the DPG data will be used in effecting navigation is sometimes referred to in this section as the “display version” of the audiovisual recording.) The data representing two versions of an audiovisual recording—which both comprise the same content—may be significantly different if the two versions were recorded under different circumstances. This may occur because of, for example, different start record times, different MSOs (Multiple Systems Operators), different frame rates, differences in signal quality (e.g., varying amounts of signal noise), different broadcast transmission technology (e.g., analog vs. digital), different encoding hardware, different encoding parameters, and differences in local commercials included in the recordings. Consequently, in order to ensure that segment definition data created from one version of an audiovisual recording can be accurately used with another version of the audiovisual recording, it is necessary to align the data representing the two versions of the audiovisual recording.

DPG data for an audiovisual recording can include alignment data (an alignment signature) for the master version of the audiovisual recording (and, in particular, the segment definition data) that, when compared to alignment data (an alignment signature) for a display version of the audiovisual recording, enables a correspondence to be established between the two versions of the audiovisual recording so that segment definition indices of the DPG data will identify the correct locations in the display version of the audiovisual recording. The alignment signatures for the master and display versions of the audiovisual recording can be computed in a standard way so that the alignment signatures can be compared to produce an alignment of the master and display versions of the audiovisual recording. In particular, alignment signatures can be computed for, and used to align, the master and display versions of an audiovisual recording as described in the commonly owned, co-pending U.S. patent application Ser. No. 11/268,752, entitled “Alignment of Different Recordings of The Same Content,” filed on Nov. 1, 2005, by Brett M. Keating et al., the disclosure of which is hereby incorporated by reference herein. The use of alignment signatures as described in that application enable alignment of master and display versions of the audiovisual recording with any degree of accuracy allowed by the granularity of the audiovisual recording data, e.g., frame-accurate alignment.

DPG data must include alignment data only if the alignment is to be performed at the audiovisual recording display location. This can be the case, for example, if apparatus that enables alignment to be performed is not present at the location that provides DPG data, or if the DPG data is created once for use by many audiovisual recording display locations. If alignment data is included in the DPG data, then alignment is performed at the audiovisual recording display location and the locations of the segment definition indices are adjusted accordingly.

However, the DPG data need not necessarily include alignment data and alignment data is not necessary if the alignment is to be performed at the DPG data providing location. In that case, alignment data produced for the display version of the audiovisual recording at the audiovisual recording display location is included as part of a request for DPG data sent to the DPG data providing location. The result of the alignment performed at the DPG data providing location is an offset function (a set of offsets for each of the frame indices of the alignment signature) between the two versions of the audiovisual recording that can be used to adjust the segment definition indices of the DPG data to be sent to the audiovisual recording display location, or that can be sent with the unadjusted DPG data to the audiovisual recording display location to enable appropriate adjustment of the segment definition indices for use with the display version of the audiovisual recording.

D. Metadata

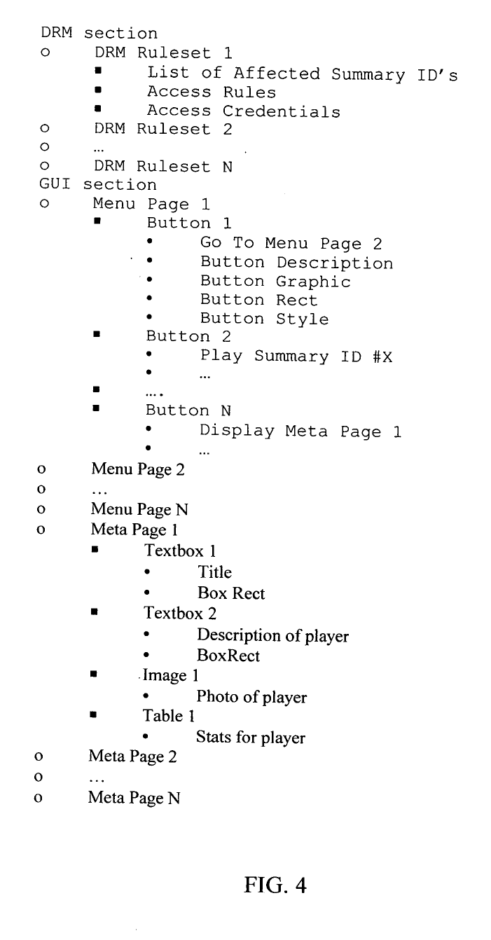

DPG data for an audiovisual recording can also include metadata that concerns one or more aspects of interacting with the data representing the segment definition indices. (However, the invention can be implemented so that the DPG data does not include such metadata.) For example, the invention can be implemented to include metadata concerning digital rights management (DRM), i.e., data that specifies the rights an observer has with regard to access to the content represented by the audiovisual recording and/or auxiliary content that may be displayed when navigating the audiovisual recording using DPG data. The invention can also be implemented to include metadata concerning presentation of a graphical user interface (GUI) that enables navigation of the audiovisual recording using the DPG data, e.g., metadata that specifies the layout and hierarchy of the GUI. Each of these types of metadata that can be included as part of DPG data are described in more detail below. FIG. 4 illustrates a data structure, according to an embodiment of the invention, that can be used in specifying metadata concerning DRM and a GUI that is included as part of DPG data.

1. Digital Rights Management Metadata

Digital rights management (DRM) metadata includes one or more sets of rules that each specify conditions that must be satisfied in order to access (typically, display, though DRM could be used to control other types of access, such as rights to modify segment definition indices) a particular part or parts of the audiovisual recording, or auxiliary content that may be displayed when navigating the audiovisual recording using DPG data. For each set of rules, the DRM metadata specifies the summary or summaries, or the auxiliary content, to which the set of rules applies. (The invention can be implemented so that a set of DRM rules applies to the entire audiovisual recording.) Additionally, DRM rules can be specified in accordance with a DRM template that can be used for more than one audiovisual recording. The discussion below regarding GUI templates and how GUI templates can be used with the invention can apply as well to the use of DRM templates with the invention.

In general, a set of rules can establish any appropriate set of conditions. For example, a set of rules can include a rule that requires first watching a commercial summary before being granted the right to display one or more parts of an audiovisual recording. Or, a set of rules can include a rule that requires providing a pass-key before being granted the right to display one or more parts of an audiovisual recording. Or, a set of rules can include a rule (which could be presented via a pop-up dialog box that includes an explanation of costs) that requires agreement to allow billing through the MSO (Multiple Systems Operator). DRM metadata can also include data that establishes credentials that must be provided to gain access to a particular part or parts of the audiovisual recording, or auxiliary content. A required credential can be, for example, a particular security key or password.

For example, in the embodiment of the invention illustrated in FIG. 4, the DRM section of the metadata specifies N sets of conditions for access to a summary or summaries produced from the audiovisual recording and/or auxiliary content that may be displayed when navigating the audiovisual recording using DPG data (DRM Ruleset 1, DRM Ruleset 2, . . . DRM Ruleset N). (To simplify illustration of this aspect of the invention, only the set of conditions for DRM Ruleset 1 are shown explicitly in FIG. 4; however, in practice, similar sets of conditions are specified for each of the other Rulesets defined in the DRM metadata.) For each set of conditions, the DRM metadata specifies the summary or summaries to which the access control applies (List of Affected Summary ID's), the rules that must be satisfied in order for access to be allowed (Access Rules), and the credentials that must be provided in order for access to be allowed (Access Credentials).

Ways in which DRM can be implemented in embodiments of the invention are described in more detail below. In particular, examples are given of rules that must be satisfied and credentials that must be provided in order for access to be allowed to a summary or summary subject to DRM.

2. User Interface Metadata

Graphical user interface (GUI) metadata can specify parameters regarding the presentation (e.g., hierarchy, layout and content) of a GUI that can be used by one or more computer programs, as known by those skilled in the art, to produce display of corresponding menu pages, dialog boxes and GUI elements that enable navigation of the audiovisual recording using the DPG data. A GUI for use with the invention can be implemented as described in the commonly owned, co-pending U.S. patent application Ser. No. 11/268,778, entitled “Graphical User Interface That Enables Rich Interaction With Indexed Audiovisual Content,” filed on Nov. 1, 2005, by Kevin Wilson et al., the disclosure of which is hereby incorporated by reference herein. In general, the invention can be implemented so that the same GUI is used with each recording of particular audiovisual content or so that multiple different GUIs can be used with different recordings of particular audiovisual content (some recordings may use the same GUI). Similarly, the invention can be implemented so that recordings of different audiovisual content can use the same GUI or can use different GUIs. The different GUIs are produced using different GUI metadata. The content of a GUI can be dependent on the content of an audiovisual recording with which the GUI is to be used and/or DPG data to be used in enabling navigation of the audiovisual recording. Aspects of a GUI for use with the invention and, in particular, the specification of GUI metadata that enables production of a GUI are described in more detail below.

A GUI for use with the invention can make use of conventional methods for producing conventional GUI elements, such as buttons, text boxes, tables, images and slider bars, as are well known to those skilled in the art. As indicated above, the hierarchy of a GUI for use with the invention can include any number of levels and each display can include any combination of GUI elements. As described above (see FIGS. 3A through 3C and associated description), the GUI can be implemented, for example, as a system of menus, each of which includes one or more menu choices that, when activated or selected, produce a corresponding action. For example, the invention can be implemented so that activation/selection of a menu choice causes the display of a new menu (with a further set of menu choices), display of a part of the audiovisual recording, display of auxiliary content related to the content of the audiovisual recording (e.g., when the invention is implemented for a recording of a sporting event, a display of statistics for a particular athlete), or display of additional GUI features that enable particular actions (e.g., a slider bar that enables editing of bookmarks or of DPG summary data as discussed below). For each element of a GUI display, the GUI metadata can include an identification of the element, a specification of the location of the element in the GUI display, a specification of the action associated with selection/activation of the element (if appropriate), and a specification of the appearance of the element (including any content included in the element, such as visual images, multimedia content, graphics or text, including text gathered from an EPG). For a recording of a football game, for example, a data structure for presenting a GUI according to the invention can specify display of content such as team logos, player names, player sound clips, game and season statistics, personalized user information, and DRM and authentication data, along with the associated layout information and identification of indices for enabling navigation of the audiovisual content.

For example, in the embodiment of the invention illustrated in FIG. 4, the GUI section of the metadata specifies parameters governing the display of N menus (Menu Page 1, Menu Page 2, . . . . Menu Page N). (To simplify illustration of this aspect of the invention, only the parameters for Menu Page 1 are shown explicitly in FIG. 4; however, in practice, similar parameters are specified for each of the other menus.) For each menu, the GUI metadata further specifies the manner of display of elements that are part of that menu. For example, for Menu Page 1, the GUI metadata specifies parameters governing the display of N buttons (Button 1, Button 2, . . . . Button N). (Again, to simplify illustration of this aspect of the invention, only the parameters for Button 1 are shown explicitly in FIG. 4; however, in practice, similar parameters are specified for each of the other buttons. Additionally, though not part of the embodiment illustrated in FIG. 4, the display of other types of GUI elements could additionally or alternatively be specified as part of the GUI metadata.) For each button, the GUI metadata further specifies the use and manner of display of that button. For example, for Button 1, the GUI metadata specifies the action associated with selection/activation of that button (Go to Menu Page 2), and a description (Button Description), graphic (Button Graphic), shape (Button Rect) and style to be used in producing the display of that button (Button Style). Selection/activation of Button 1 causes the display of a new menu. As illustrated in FIG. 4, parameters are specified for Button 2 and Button N such that selection/activation of Button 2 causes display of a part of the audiovisual recording (Play Summary ID #X) and selection/activation of Button N causes display of auxiliary content related to the content of the recording (Display Meta Page 1). The GUI metadata also specifies parameters governing the display of auxiliary content (Meta Page 1, Meta Page 2, . . . . Meta Page N). (Again, to simplify illustration of this aspect of the invention, only the parameters for Meta Page 1 are shown explicitly in FIG. 4; however, in practice, similar parameters are specified for other auxiliary content.) For each display of auxiliary content, the GUI metadata specifies the elements that are part of that auxiliary content display, as well as the parameters that govern the display of those elements. For example, Meta Page 1 includes two text boxes, an image and a table. For each of the text boxes, the GUI metadata specifies the content of the text box (“Title” for Textbox 1 and “Description of player” for Textbox 2) and the shape of the text box (BoxRect for both Textbox 1 and Textbox 2). For the image, the GUI metadata identifies the image to be displayed (Photo of player). For the table, the GUI metadata identifies the content to be included in the table (Stats for player).

Presentation of a GUI that enables navigation of an audiovisual recording using DPG data for that audiovisual recording can be effected in ways other than by explicit specification of all of the necessary parameters in metadata of the DPG data. For example, one or more parameters regarding the presentation of a GUI can be specified in a template (multiple GUIs can be represented by multiple such templates) that can be used for multiple audiovisual recordings. In the extreme case, the DPG data for a particular audiovisual recording need then only include metadata (GUI template ID) that identifies a GUI template for use in presenting a GUI for that audiovisual recording (assuming more than one GUI template is available), all of the necessary parameters being supplied by the GUI template. In other embodiments of the invention, only some of the necessary parameters are provided by the GUI template. (In such embodiments, the DPG data again must include metadata that identifies a GUI template.) For example, the invention can be implemented so that the location of GUI elements is provided by a GUI template. The invention can further be implemented so that parameters such as a description and/or graphic for GUI elements is provided by metadata of the DPG data for an audiovisual recording. Available GUI templates can be provided to locations at which navigation using DPG data will occur together with an audiovisual recording, with DPG data, or separately. In general, any number of GUI templates can be provided to each of such locations. The more GUI templates that are provided to a location, the greater flexibility in producing a GUI display that is appropriate for the content of a particular audiovisual recording and/or a particular set of DPG data.

A single generic GUI template can be provided for use with audiovisual recordings. In that case, the DPG data for a particular audiovisual recording need not include a GUI template ID. However, the invention can also be implemented so that multiple GUI templates are available for use with an audiovisual recording. In that case, the DPG data for a particular audiovisual recording can include a GUI template ID (assuming a GUI template is to be used) identifying an appropriate GUI template for use with the audiovisual recording. GUI templates can be provided for use with particular audiovisual recordings based on any of a number of possible characteristics of an audiovisual recording, such as, for example, the subject matter of the audiovisual recording, the entity who produced or owns the audiovisual recording, the entity for which the audiovisual recording will be displayed, or the location at which the audiovisual recording will be displayed (there are many other possibilities).

The invention can also be implemented so that some or all of the necessary parameters for presenting a GUI are automatically determined based on one or more characteristics of the audiovisual recording (as discussed above) with which the GUI will be used. For example, in some embodiments of the invention, a GUI template can be identified for use with an audiovisual recording based on characteristic(s) of the audiovisual recording. (In such embodiments, the DPG data need not include metadata that identifies a GUI template if the GUI template identified based on characteristic(s) of the audiovisual recording specifies all of the necessary parameters for the GUI; if not, the other parameters can be supplied by a second GUI template identified by metadata in the DPG data and/or by explicit specification of parameters for use in presenting the GUI.) For instance, a GUI template can be selected based on an automatic determination of the type of subject matter (e.g., sporting event, situation comedy, talk show, news program, etc.), which can be ascertained from broadcast information (i.e., metadata broadcast with the audiovisual content of the recording) and/or EPG information. As one illustration, a particular GUI template can be used for a broadcast of a sporting event or, more particularly, a particular GUI template can be used for a broadcast of a particular type of sporting event (e.g., particular GUI templates can be used for each of football, baseball, basketball, hockey, soccer, etc.; particular GUI templates can be used for particular sports teams). When DPG data (e.g., segment definition data) is determined automatically, as described further below, it may be difficult or impossible to automatically specify parameters for a GUI (as part of automatically determining the DPG data) that will ensure provision of a desired experience in observing the audiovisual recording, e.g., presentation of a GUI that is relevant to the subject matter of the audiovisual recording. Implementing the invention so that a GUI template can be selected based on characteristic(s) of the audiovisual recording can ameliorate this problem by providing presentation of a GUI with relevance to the audiovisual content displayed, e.g., a football-themed GUI for a broadcast of a football game.

A combination of the approaches discussed above can be used. For example, the parameters of a GUI can be specified in part by a GUI template and in part explicitly as part of GUI metadata of DPG data. One or multiple GUI templates can be used. If multiple GUI templates are used, one or more can be specified by GUI metadata of DPG data and/or one or more can be automatically determined based on characteristic(s) of the audiovisual recording.

### V. DPG Data Creation and Editing

DPG data for an audiovisual recording can be created and edited automatically and/or manually. Automatic creation or editing of DPG data entails creation or editing of at least segment definition indices by computational apparatus operating in accordance with one or more computer programs adapted to effect evaluation of the audiovisual recording data (and/or associated data, such as closed-caption data and electronic program guide data) without human intervention during the creation or editing (as discussed below, manually created DPG data can also be modified automatically). Manual creation or editing of DPG data entails specification of at least segment definition indices in response to, at least in part, specification of a segment definition index by a person. Either automatically created DPG data or manually created DPG data can also be modified manually. Manually created DPG data can also be modified automatically. Either of automatic or manual creation or editing of DPG data can be performed at the same, or a different, location as that at which the DPG data is used to navigate the audiovisual recording. The same or similar methods and apparatus can be used in each case. Both automatic and manual creation and editing of DPG data are discussed in more detail below. Methods and apparatus for creating and editing DPG data (in particular, creating and editing segment definition indices) that can be used with the invention are also described in the above-referenced U.S. patent application Ser. No. 11/268,778, as well as the commonly owned, co-pending U.S. patent application Ser. No. 11/268,713, entitled “Generation And Exchange of a Summary of Audiovisual Content Without Transferring Any of The Audiovisual Content,” filed on Nov. 1, 2005, by Sundar R. Vedula et al., the disclosure of which is hereby incorporated by reference herein.

A. Automatic Creation and Editing of DPG Data

As indicated above, the invention can be implemented so that DPG data can be created or edited automatically by evaluating audiovisual recording data. In particular, data regarding segment definition indices (i.e., data that identifies segment(s) in an audiovisual recording) can be created or edited automatically by evaluating audiovisual recording data. In general, any method for identifying a segment or segment definition index can be used. However, it is desirable to identify segments that can be used to create pleasing and relevant summaries from the audiovisual recording content, so, to that end, the invention can be implemented to evaluate audiovisual recording data to identify audio and/or visual cues that are likely to denote the beginning or end of such segments.

There are a variety of methods that can be used to identify a segment or segment definition index. For example, certain changes in content in an audiovisual recording can be identified as a location corresponding to the beginning and/or end of a segment. Such changes in content include, for example, a transition (e.g., a camera cut), a film effect (e.g. a fade, a dissolve, a wipe), a speaker change or a general change in background noise. A part of an audiovisual recording can also be identified as a segment using methods for identifying the occurrence of a phenomenon or phenomena that may indicate content of interest, such as the presence of speech (instead of, for example, silence or music) or the occurrence of laughter or applause. Any of a variety of methods known to those skilled in the art can be used to evaluate audiovisual recording data to identify the presence of the foregoing in an audiovisual recording, and those methods can be used in embodiments of the invention. For example, cuts, fades and dissolves can be identified in an audiovisual recording using a method or methods as described in commonly owned, co-pending U.S. patent application Ser. No. 09/792,280, entitled “Video Processing System Including Advanced Scene Break Detection Methods for Fades, Dissolves and Flashes,” filed on Feb. 23, 2001, by Michele Covell et al., or in commonly owned, co-pending U.S. patent application Ser. No. 09/595,615, entitled “Video Processing System,” filed on Jun. 16, 2000, the disclosures of each of which are hereby incorporated by reference herein.

When an audiovisual recording includes commercials (e.g., most television and radio broadcasts), identification of the presence and location of commercial breaks in the audiovisual recording can be used to define segments that can be used to create a summary of the audiovisual recording. For example, a specified duration of time (e.g., one or two minutes) after the end of a commercial break (which can include one or more commercials) can be defined as a segment. A good summary for many television shows—one that can often enable a viewer to quickly determine if the show is of interest for further viewing—can be produced by including in the summary segments determined in this manner. Or, for example, each part of an audiovisual recording between commercial breaks can be defined as a segment. (Within each such segment, sub-segments can be defined using other methods described herein.) This can be useful to produce a commercial-free summary of the audiovisual recording. The boundaries of such segments an also be used to define chapter breaks if the audiovisual recording is to be stored on one or more DVDs.

The invention can advantageously be implemented to make use of methods for identifying a segment (i.e., segment definition indices) that rely on semantic categorization of the content of an audiovisual recording. The following description of identifying segments in a broadcast of a sporting event is a example of implementation of the invention in this way. In one embodiment of the invention, segment definition indices are automatically detected based on an evaluation of audiovisual content other than a transition (cut) or film edit (e.g., fade, dissolve).

In many broadcasts of a sporting event, there is quite a bit of audiovisual content that does not include action that is part of the sporting event. For example, a football game or baseball game includes quite a bit of time between plays or pitches (and ensuing action). Such broadcasts are well suited to the use of summaries or other navigation tools that enable an observer of the broadcast to skip some, most or all of the extraneous audiovisual content. The invention can advantageously be used to produce DPG data for a broadcast of a sporting event that can be used for this purpose. In particular, methods for identifying segment definition indices that rely on semantic categorization of the content of an audiovisual recording, as mentioned above, are especially useful for such an application.

For example, the invention can be implemented to evaluate the content of a broadcast of a baseball game to produce DPG data (in particular, segment definition indices) for the broadcast. Since action in a baseball game generally begins with a pitch, the invention can make use of a semantic detector to detect the occurrence of pitches in the baseball game. The semantic detector can be implemented to make use of an image similarity detection method to compare a visual image of the broadcast to a prototype “pitch” image and determine whether the visual image includes a pitch. For instance, a measurement of the error (difference) between a visual image of the broadcast and a prototype “pitch” image can be measured: if the error is below a specified threshold, then the visual image is determined to include a pitch. In general, any method for determining image similarity or the presence of relevant action can be used (for this, or any other, application of the invention). For example, the invention can make use of an image similarity method as described in commonly owned, co-pending U.S. patent application Ser. No. 11/176,010, entitled “Process-Response Statistical Modeling of a Visual Image For Use in Determining Similarity Between Visual Images,” filed on Jul. 5, 2005, by Brett M. Keating et al., the disclosure of which is hereby incorporated by reference herein. The semantic detector can also be implemented to detect the presence or absence of relevant action after the occurrence of a pitch by evaluating visual images subsequent to the detection of a pitch (the presence of action can both confirm that a previous visual image or images likely included a pitch and can identify visual images that should be included in a segment together with the visual image(s) including a pitch). Relevant action after a pitch can be detected by measuring the amount of action in visual images subsequent to the occurrence of a pitch: if visual images after a pitch are determined to have greater than a specified amount of action, then the visual images are determined to include relevant action. The measurement of the amount of action in visual images can be accomplished, for example, using motion estimation, in which global motion vectors between adjacent frames are estimated using error minimization techniques such as exhaustive search and/or least squares. Additionally or alternatively, since relevant action after a pitch often results in the production of visual images from a video camera aimed at the field, which is typically green, the presence of absence of relevant action after a pitch can be determined by measuring the amount of green in visual images subsequent to the occurrence of pitch: if visual images after a pitch are determined to include greater than a specified amount of green, then the visual images are determined to include relevant action. The amount of green present in a visual image can be determined using methods well known to those skilled in the art of visual image analysis. Other cues can be used to aid in the automated detection process, such as the rapidity of camera cuts (a relatively high number of cuts tends to indicate relevant action after a pitch, increases in audio volume (an increase in audio volume generally indicates the presence of relevant action after a pitch), and proximity to commercial breaks (visual images very close to a commercial break typically do include a pitch or relevant action after a pitch). Using the detection of the occurrence of pitches and the determination of the presence or absence of relevant action subsequent to the occurrence of a pitch, segments can then be defined (i.e., appropriate indices specified) as series of visual images including a pitch and any relevant action occurring after the pitch. All identified segments can be combined to form a summary. Or, each segment can be ranked according to the likelihood that the segment includes action that is part of the baseball game, and a subset of the segments with the highest likelihood measures selected for inclusion in a summary that is intended to capture the most salient plays in the game. The likelihood that a segment includes action that is part of the baseball game can be computed as a combination of the measures used to identify visual images for inclusion in the segment, i.e., as a combination of the degree to which a visual image is determined to be likely to include a pitch or relevant action after a pitch. A weighted combination can be used in which different measures are given different degrees of influence on the likelihood computation.

Above, a variety of methods for identifying a segment or segment definition index are described. These methods can be combined, which can increase the confidence with which segments or segment definition indices are identified. For example, each of multiple methods for identifying a segment or segment definition index can be performed to produce a result indicating a degree of confidence in identification of a segment or segment definition index. The results for each method can then be combined. The combination can be a weighted combination which gives different degrees of influence on the overall result to different methods.

Above, automatic identification of segment definition indices is described in detail. However, other DPG data can also be determined automatically. For example, as described above, some or all of the necessary parameters for presenting a GUI can be automatically determined based on the content of the audiovisual recording, e.g., a GUI template can be identified for use with an audiovisual recording based on the content of the audiovisual recording. Similarly, a DRM scheme (template) can also be identified for use with an audiovisual recording based on the content of the audiovisual recording.

B. Manual Creation and Editing of DPG Data

As also indicated above, the invention can be implemented so that DPG data can be created and edited manually. In particular, the invention can implemented so that data regarding segment definition indices can be created and edited manually. For example, the invention can be implemented so that DPG data is created or edited by a person as the person observes an audiovisual recording being displayed in a conventional manner (e.g., a segment definition index or indices are created during conventional observation of an audiovisual recording by enabling a person to provide one or more segment identification inputs when a part of an audiovisual recording is encountered that it is desired to save as a segment). Or, the invention can be implemented so that DPG data is created or edited by a person interacting with an audiovisual recording editing system that allows greater flexibility in interacting with an audiovisual recording than that provided by conventional display apparatus. Or, DPG data created during observation of an audiovisual recording being displayed in a conventional manner can be modified using an audiovisual recording editing system.

As indicated above, segment definition indices for a segment can be established by providing one or more segment identification inputs. For example, two segment identification inputs can be provided that define start and end indices for a segment at the locations in an audiovisual recording being displayed at the times of input (these locations can be automatically adjusted, as discussed below). To inhibit accidental index creation, the invention can be further implemented to establish a minimum time window that precludes creation of an end index less than a specified amount of time or number of frames after creation of a start index, and/or, to inhibit accidental failure to create an end index, a maximum time window can be specified that mandates creation of an end index if one has not already been created. Or, a single segment identification input can be provided which establishes start and end indices for a segment. For example, the segment identification input can establish a start or end index at the location in the audiovisual recording being displayed at the time of input (again, this location can be automatically adjusted, as discussed below), with the other of the start and end index being automatically established in accordance with a specified criterion or criteria, e.g., an adjacent index that has been previously established, a new index located a specified duration of time or number of frames from the index created by the segment identification input. Or, for example, both start and end indices can be automatically defined that have a specified relationship to the location of a segment identification input, e.g., a segment can be defined that is centered on—or otherwise located with respect to—the location of the segment identification input and has a specified duration of time.

Additionally, DPG data created automatically, as described above, can be modified manually. For example, one or more segment definition indices determined automatically can be deleted from DPG data. One or more manually created segment definition indices can be added to a set of automatically determined segment definition indices. Or, the location of one or more automatically determined segment definition indices can be manually adjusted. Manual modification of automatically determined DPG data can be done in the ways described above, i.e., by a person as the person observes an audiovisual recording being displayed in a conventional manner, or by a person interacting with an audiovisual recording editing system that allows greater flexibility in interacting with an audiovisual recording than that provided by conventional display apparatus. Manual modification of automatically determined DPG data may be desirable, for example, to increase the likelihood that segment definition indices are placed at appropriate locations, since automatic determination of segment definition indices may not always succeed in meeting that goal.

Additionally, DPG data created manually can be modified automatically. For example, there is likely to be a short delay between when a person sees something interesting and when the person provides a segment identification input to indicate an index. Thus, it can be desirable to automatically adjust indices specified manually by a constant negative offset (which can be specified either as a duration of time or a number of frames). Alternatively, a manually specified index can be automatically adjusted in accordance with automatic evaluation of proximate content in the audiovisual broadcast. The automatic evaluation of content can be implemented using any appropriate technique that identifies events (frames) that are likely to indicate the beginning or end of a segment, as discussed above with respect to automatic creation of segment identification indices, such as a transition (e.g., camera cut) or film effect (e.g., fade, dissolve). A manually designated index can be changed to be the closest frame corresponding to a detected event. Such “event” frame can further be required to be within a specified number of frames of the manually designated index. Further, in addition to, or instead of, use in modifying an index designated by a person, automatic evaluation of content to identify events that are likely to indicate the beginning or end of a segment can be used to alert the person to segment starts or ends that the person may have missed.

Manual creation and editing of DPG data can be enabled using a variety of user interface apparatus and methods. For example, a remote control device similar in construction to those used to control a variety of consumer electronic apparatus, can be implemented to include a “bookmark” button that can be activated (e.g., depressed) when, during conventional display of an audiovisual recording, a part of the audiovisual recording is encountered at which it is desired to specify an index (e.g., when content of interest is displayed). Or, such a bookmark button can be included on audiovisual recording display apparatus such as an HDD or DVD recorder, or a PVR. The remote control device can also be adapted to include buttons that enable creation and editing of segment definition indices using an audiovisual recording editing system. Or, if the audiovisual recording is stored on a portable data storage medium or media, such as a DVD, CD, flash memory storage devices or a USB removable storage apparatus, that can be accessed using a computer, manual creation and editing of DPG data (in particular, segment definition data) can be effected using editing software operating on that computer.

The invention can also be implemented to present a graphical user interface (GUI) on display apparatus (e.g., television) that enables creation and editing of segment definition indices. The GUI can be implemented to enable creation/modification of indices during playback of an audiovisual recording and/or using a system of navigational menu(s).

For example, during viewing of an audiovisual recording, an OSD menu can be presented that includes a GUI mechanism (e.g., graphical pushbutton) which can be used to provide a segment identification input. The invention can be implemented so that each time the GUI mechanism is activated, a start or end index is specified at the location in the audiovisual recording being displayed at the time of activation (the location of the index can be adjusted, as discussed above). To facilitate definition of segments in this way, the OSD menu can include an indicator that flashes after a start index is specified to show that a segment definition has been initiated, and turns off when an end index is specified. Or, the invention can be implemented so that, in response to a segment identification input, start and end indices are automatically defined that have a specified relationship to the location of the segment identification input, as discussed above. The GUI can be further implemented to enable adjustment of the manner in which such automatic segment definition occurs (e.g., modification of the duration of time of the segment).

An OSD menu can also be implemented to include a slider bar that shows indices for a specified window of the audiovisual recording (which can be the entire audiovisual recording). Moving the slider bar can cause display of the time or frame number in the audiovisual recording. By appropriately positioning the slider bar, existing indices can be edited (e.g., by using conventional GUI mechanisms to “grab” an index and move the index along the slider bar), and existing indices can be deleted and new indices created (e.g., by activating a GUI mechanism, such as a graphical pushbutton, that effects the corresponding operation).

Or, for example, the GUI can be implemented to enable selection of a particular audiovisual recording, which then causes display of a navigational menu that identifies available sets of indices for that audiovisual recording. A particular set of indices can be selected for viewing. The GUI can be implemented to display a slider bar on which the existing indic(es) for that set are displayed, as described above, which can be used to add, delete and/or modify indices in the manner described above. Or, instead of displaying indices on a slider bar, the indices can be presented in a table, which can be edited to add, delete or modify existing indices.

A GUI can also be implemented to enable creation of an identifiable set of indices. This can aid in managing multiple sets of indices for a particular audiovisual recording, as well as indicate authorship of sets of indices. For example, the GUI can be implemented to open and label a new set of indices, with every index created thereafter being included as part of that set of indices until the set is closed. An observer can use this functionality to create an original highlight summary (one or more segments) for an audiovisual recording (which can be shared with others, as described elsewhere herein). The highlight summary can be stored and cataloged together with highlight summar(ies) for that audiovisual recording created by others. To further aid in management of segment definition indices, a GUI can be implemented so that individual indices or segments of a summary can also be labeled.

Additionally, a GUI can be implemented to enable, in addition to the creation and editing of indices, identification of single visual images from the audiovisual recording to be saved, and, if desired, shared with others, as described elsewhere herein.

### VI. DPG Data Transmission

As discussed above, DPG data can be created at a location that is different from that at which an audiovisual recording will be displayed and DPG data used to navigate the audiovisual recording. In such case, the DPG data can be transmitted in a variety of ways to the location at which the DPG data will be used.

For example, the invention can advantageously be implemented so that an audiovisual content observation subsystem and a DPG data creation subsystem are part of a communications network via which data can be transmitted between the two locations. The communications network can be, for example, a computer network such as the Internet, a television network, or a telephone network (including a conventional and/or cellular telephone network). The communications network can make use of wired communication (e.g., the Internet, a LAN, an ATM network or a conventional telephone network) and/or wireless communication (e.g., wireless LAN, Bluetooth, or a cellular telephone network). The communications network can make use of any appropriate communications protocol, such as HTTP, HTTPS, UPnP, RTSP, TCP/IP, Bluetooth, etc. Herein, “communications network encompasses any of these ways of implementing a communications network unless specifically stated otherwise.

Alternatively, the DPG data can be stored on a portable data storage medium (a large variety of which are known and can be used with the invention, such as one or more CDs, DVDs, flash memory storage devices and/or USB removable storage apparatus) at the DPG data creation location using apparatus such as a DVD or CD drive with write capabilities, sent to the audiovisual recording display location (by, for example, mail or other delivery service), then accessed using apparatus adapted to read data stored on the portable data storage medium, such as a DVD or CD player.

### VII. DPG Data Sharing

As described above, the invention can be implemented so that DPG data is created at a location different from that at which the DPG data is used to enable navigation of an audiovisual recording during display of the audiovisual recording, and provided to that location in some manner (e.g., via a communications network or by storing the DPG data on a portable data storage medium or media that is delivered to the audiovisual recording display location by mail or courier), i.e., DPG data is created at a “remote location” and provided to an audiovisual recording display location. As described elsewhere herein (see, e.g., FIG. 2 and associated description above), the invention can be implemented so that DPG data is created by a DPG data service provider system (i.e., an entity having a primary purpose of creating DPG data for dissemination for use at many audiovisual recording display locations) and provided to one or more audiovisual recording display locations.

However, the invention can be implemented to enable sharing of DPG data between or among audiovisual recording display locations, typically by entities (e.g., residential television viewers) not having a primary purpose of disseminating DPG data. (The invention can also be implemented to enable sharing of other data, such as data representing video, still visual images and/or audio.) In particular, the invention can be implemented to enable DPG data created at an audiovisual recording display location to be shared with one or more other audiovisual recording display locations. Such DPG data can be created automatically or manually, as described above. For example, DPG data created at an audiovisual recording display location by bookmarking segments as an audiovisual recording is displayed, as described above, can be shared with other audiovisual display recording locations. DPG data created at an audiovisual recording display location can be provided to other audiovisual recording display locations in the same ways that DPG data created by a DPG data service provider system can be provided to those locations, e.g., depending upon the particular implementation of the invention, via a communications network or by storing the DPG data on a portable data storage medium or media (e.g., optical data storage medi(a) such as one or more CDs or one or more DVDs, flash memory storage devices or USB removable storage apparatus) that is delivered to the audiovisual recording display location by mail or courier. For instance, in some locales, television content is now commonly stored on flash memory storage card. The invention can enable a summary of television content (identified by DPG data and determined automatically or manually) to be stored alone on a flash memory storage card or together with the corresponding television content. The invention can also be implemented to provide one or more locations to which DPG data created at an audiovisual recording display location can be provided, from which location(s) the DPG data can be disseminated. For example, DPG data created at an audiovisual recording display location can be provided to a server at a node of network (e.g., a computer network such as the Internet, a television network, or a telephone network including a conventional and/or cellular telephone network) which can receive such DPG data from multiple—e.g., thousands or, conceivably, millions—audiovisual recording display locations and which then makes the DPG data available for request (e.g., via a web site) by other audiovisual recording systems. Or, for example, DPG data created at an audiovisual recording display location can be made available via a peer-to-peer network architecture in which DPG data can be made available and provided directly from one audiovisual recording display location to another audiovisual recording display location. When the DPG data is shared via a network, the DPG data can be made available directly from the apparatus used to create the DPG data (e.g., a computer, or a PVR, a DVD recorder or a set-top box having computational capability to enable creation of DPG data) or can be transferred to another apparatus to enable communication via the network. Implementing the invention to enable sharing of DPG data between or among audiovisual recording display locations can enhance usage of DPG data by providing a potentially large number of sources of DPG data with resultant large number of possible audiovisual recording observation experiences and by providing an opportunity for “community building” among users of DPG data.

DPG data (and other data) can be received by an audiovisual recording display location silently by the automatic polling of one or more computer program(s) operating at the audiovisual recording display location, then seamlessly and dynamically displayed (e.g., using a GUI). Or, DPG data can be received through a process of exchange and refinement with a DPG data service provider system or other audiovisual recording display location, as described in detail in the above-referenced U.S. patent application Ser. No. 11/268,713. The invention can be implemented to require an audiovisual recording display location to accept or decline DPG data (and other data) transferred to the audiovisual recording display location.

A GUI for use with DPG-enabled apparatus can be implemented to present the interactive ability to publish DPG data (i.e., transmit DPG data to other locations via a communications network), as described above. (Sharing of DPG data can also be accomplished by archiving or otherwise storing the DPG data on portable data storage medi(a) which is then delivered to a designated location.) The GUI can be implemented to enable publishing of DPG data during playback of an audiovisual recording and/or using a system of navigational menu(s). For example, an observer of an audiovisual recording may have just created a “bookmark” in playback mode and want to share this “bookmark” (or a whole set of bookmarks) with a family member and/or “buddy list” of friends who have the same audiovisual recording stored on DPG-enabled apparatus. A GUI can be implemented to present a set of destination options upon indication of a desire (which can be effected, for example, using a GUI element in an OSD menu) to publish DPG data. Upon selection of destination option(s), the DPG data to be published can be placed in “publish queue,” which can then be viewed and managed from a “publish menu.”

A GUI for use with DPG-enabled apparatus can also be implemented to present the interactive ability to receive DPG data and other data, either via a network or by accessing a portable data storage apparatus delivered to the location of the DPG-enabled apparatus, in any of the ways discussed above for enabling communication of DPG data from one location to another. In addition to the ways described above for receiving DPG data, DPG data can be requested explicitly, using, for example, an appropriate GUI element (e.g., graphical pushbutton) of a GUI that can be presented in a navigational menu or an OSD menu. The GUI can display a list of available sets of DPG data and enable request for receipt of any of them. The GUI can also be implemented to present a GUI element (e.g., a dialog box) that enables acceptance or refusal of DPG data (and other data) that is attempting to be transferred to an audiovisual recording display location.

### VIII. Monitoring Usage of DPG Data

The invention can be implemented to enable monitoring of the display of an audiovisual recording in which DPG data is used to navigate the audiovisual recording. In particular, aspects of the display can be monitored that particularly pertain to the DPG data (e.g., a summary defined by segment identification indic(es)). The invention can be implemented to collect usage statistics and/or user feedback regarding display of the audiovisual recording or parts thereof. Below, aspects of implementation of the invention to enable monitoring of the display of an audiovisual recording in which DPG data is used to navigate the audiovisual recording are described. Such monitoring is also described in the above-referenced U.S. patent application Ser. No. 11/268,713.

Such monitoring can be useful in identifying deficiencies in DPG data, such as a segment definition index or indices that appear not to represent a location of content of interest in an audiovisual recording display. Consequently, it can be desirable for the entity that created and/or provided the DPG data (such as a DPG data service provider) to know such monitoring information (this is especially so when DPG data is automatically determined, since the entity in charge of creating and/or providing the DPG data may not have specific knowledge of the content of the DPG data), since it may enable modification of the DPG data in a way that makes the DPG data more useful in navigating the audiovisual recording display.

Any of a variety of things can be monitored regarding the display of an audiovisual recording in which DPG data is used to navigate the audiovisual recording (and, in particular, aspects of the display that particularly pertain to the DPG data). It can be particularly useful to monitor aspects of the display that reflect interaction with the display by an observer. For example, behavior of an observer in controlling the audiovisual recording display after navigating to a location (for convenience, sometimes referred to herein as a “DPG location) in the display corresponding to a particular segment definition index can be monitored. For instance, the invention can be implemented to monitor the occurrence (e.g., the number of occurrences and/or the frequency of occurrence) of rewinding and/or fast-forwarding an audiovisual recording display after navigating (e.g., within a specified period of time of navigating) to a DPG location. A high incidence of rewinding and/or fast-forwarding may be taken to indicate a lack of interest in the content of the audiovisual recording display occurring immediately after the DPG location, which may indicate that placing a DPG index at that location is not beneficial. Further, the duration of the rewind or fast-forward can be monitored: a sufficiently large number of rewinds or fast-forwards that end at a location proximate to other locations at which a rewind or fast-forward ends may indicate that a segment definition index should be placed at a location proximate to those locations. Or, for example, the frequency with which segments in an audiovisual recording are viewed can be monitored, giving an indication of the parts of an audiovisual recording that are most and least popular. Again, this information may be used to modify the DPG data: for example, segment definition indices for a segment or summary that is viewed with less than a specified frequency may be removed from the DPG data. Or, for example, the frequency with which particular audiovisual recordings are viewed can be monitored, giving an indication of which audiovisual recordings are most and least popular.

Further, the invention can also be implemented to provide user interface apparatus (e.g., a remote control device including appropriate buttons or other user input mechanisms, or a GUI including appropriate GUI elements) that enables users to express particular sentiments regarding display of the audiovisual content. For example, an observer of the audiovisual content can express approval or disapproval of the audiovisual content, or indicate a satisfaction level. Or, as described above, an observer of the audiovisual content can specify bookmarks. In addition to, on instead of, being used to produce segment definition indices, as described above, statistics regarding the location of bookmarks in the recording can be collected.

Monitoring data regarding aspects of the audiovisual recording display can be recorded and provided in a manner that enables review by an entity having an interest in how observers of the audiovisual recording display interact with the display in ways that pertain to the DPG data (and, in particular, the segment definition indices). For example, the monitoring data can be provided directly to the entity that created and/or provided the DPG data, either by communicating the data via a network or otherwise (e.g., on a portable data storage medium delivered by mail or courier). This can be appropriate, for example, when the DPG data was created and/or provided by a DPG data service provider. Or, for example, the monitoring data can be provided to an entity that did not create or provide the DPG data (for convenience, referred to hereinafter as a “DPG monitoring data collector”), but that gathers monitoring data regarding many different audiovisual recording displays that can make use of the same or different sets of DPG data (typically, in such case, monitoring data regarding many different sets of DPG data is collected). This can be appropriate, for example, for DPG data that is created and/or provided from an audiovisual recording display location by an entity (e.g., a residential television viewer) not having a primary purpose of disseminating DPG data. The DPG monitoring data collector provides a single repository for DPG monitoring data from which the monitoring data can be obtained by the entities that created and/or provided the DPG data. In particular, this aspect of the invention can be implemented so that DPG monitoring data can be retrieved via a communications network, e.g., the DPG monitoring data can be made available on a Web site provided by the DPG monitoring data collector.

Logging of usage statistics and/or user feedback can be a powerful aspect of the invention. The alignment in accordance with the invention enables accurate monitoring of the display of a recording so that accurate usage statistics and/or user feedback can be obtained. In particular, the alignment of recordings in accordance with the invention can enable frame-accurate usage statistics and/or user feedback to be obtained, providing finely grained information not previously available to content providers (including advertisers). For example, in addition to helping improve summaries with minimal human interaction, usage statistics and/or user feedback can be used as a basis for providing particular content (e.g., targeted advertisements or other relevant content) to particular audiovisual content observers. Such usage statistics and user feedback can enable charging advertisers using a variety of business models, such as higher rates for advertisements that are displayed with greater frequency at summary display locations. The frequency of advertisement display can be monitored in a variety of ways, such as, for example, by defining a commercial in a broadcast as a summary and monitoring the display of the commercial, monitoring the display of audiovisual content that is known to include the advertisement, or by monitoring the display of advertisements in menus of a GUI.

### IX. Archiving DPG Data

It may be desired to archive part or all of an audiovisual recording together with DPG data that can be used to navigate the audiovisual recording. The invention can be implemented so that an audiovisual recording and associated DPG data can be archived by storing the audiovisual recording and DPG data on a portable data storage medium or media, e.g., optical data storage medi(a) such as one or more CDs or one or more DVDs, flash memory storage devices or USB removable storage apparatus. The invention can also be implemented so that an audiovisual recording and associated DPG data can be archived by transmitting the audiovisual recording and DPG data via a communications network to another location on the network and storing the audiovisual recording and DPG data on data storage apparatus at that location, e.g., storing the audiovisual recording and DPG data a personal computer or a PVR. As discussed in more detail below, the invention can enable archiving part or all of an audiovisual recording together with DPG data that can be used to navigate the audiovisual recording so that the segment definition indices are maintained, even if archival requires changing the format of the audiovisual recording and DPG data.

For example, the invention can be implemented to enable archival of an audiovisual recording together with DPG data by storing the audiovisual recording and DPG data on one or more DVDs. Archival on DVDs entails converting the audiovisual recording data and DPG data into a form compatible with the DVD specification and DVD players. GUI metadata of the DPG data is converted into data (.IFO files, associated graphics, etc.) that enables generation of DVD menus according to the DVD specification, so that the DVD menu interface forms a user interface that matches the DPG user interface inasmuch as the DVD specification allows. The audiovisual recording data is converted into a format appropriate for storage on a DVD, which is typically MPEG-2 video contained in .VOB files. Additionally, the DVD is finalized so that the DVD is viewable on most DVD players.

Other modifications to the DPG data may also be made to facilitate archival on to DVD. For example, as indicated above, the invention can be implemented so that selection of “next” and “previous” graphical pushbuttons (or other GUI mechanisms) enable, respectively, skipping ahead to the beginning of a next part of the audiovisual recording or skipping back to the beginning of the part of the audiovisual recording currently being displayed (or, if at the beginning of a part of the audiovisual recording, to the beginning of the part of the audiovisual recording, if any, immediately prior to the one currently being displayed). The DPG data can be specified to enable the “next chapter” and “previous chapter” buttons of a DVD user interface (which typically appear both on the remote control and the front panel of most DVD players) to be used to obtain the same experience. The start segment definition index for the first segment of a summary and the end segment definition index for the last segment in a summary can be specified as DVD chapter start and end points. During storage of the audiovisual recording on DVDs, chapter cells can be placed at the above-indicated start and end segment definition indices. If the number of summaries exceeds the limit imposed by the DVD specification for number of chapters, the summaries can be stored on multiple DVDs.

Or, for example, the invention can be implemented to enable archival of an audiovisual recording together with DPG data by storing GUI metadata of DPG data in a format such as HTML or Macromedia Flash. Since these formats are similar, only archival in HTML format is described below. Each DPG menu page can be represented by an individual HTML page. A menu choice on a DPG menu page that, when activated/selected, causes the display of a new menu (with a further set of menu choices) can be represented in the corresponding HTML page by a hyperlink to another HTML page (which represents the DPG menu page corresponding to that DPG menu choice). A menu choice on a DPG menu page that, when activated/selected, causes the display of a part of the audiovisual recording can be represented in the corresponding HTML page by a link that, when selected, causes display of the part of the audiovisual recording using-audiovisual playback computer program such as Windows Media Player, Quicktime, or other audiovisual playback computer program.

The invention can also be implemented to enable archival of a part of an audiovisual recording together with associated DPG data. As described above, a set of DPG data can include specification of multiple summaries (i.e., multiple sets of segment definition indices), which can be organized in a hierarchy that is represented by the GUI metadata of the DPG data (see, e.g., FIGS. 3A through 3C and associated description above, and FIGS. 5A through 5D and associated description below). One or more of the summaries can be selected for archival, together with, as desired, the corresponding parts of the GUI metadata (and, if applicable, DRM and alignment metadata), thus producing a shorter edited version of the audiovisual recording. This archival capability can advantageously enable a person to save only a part of a show (which can be particularly advantageous when the available data storage is adequate for the part of the show, but not the entire show), or share a favorite part of a show with friends. As described above for sharing of DPG data, the archived content can be shared by communicating the archived content via a network or by storing the archived content on portable data storage medi(a) that can be delivered by mail or courier.

A GUI can be implemented to present one or more navigational menus that enable archival of audiovisual content and/or related data on a portable data storage medium or media as described above. In particular, the GUI can be implemented so that archival capability is presented in close relation to index creation, editing and publishing capabilities (discussed elsewhere herein).

### X. DPG Business Models

A Deep Program Guide provides increased richness in how an audiovisual recording can be observed. The economic value provided by a Deep Program Guide can be extracted in a number of ways. Further, that economic value can be extracted to accrue to one or multiple entities. Below, some embodiments of the invention are described in which the economic value of a Deep Program Guide can be realized in different ways. The manner in which the economic value provided by a Deep Program Guide is extracted can be related to the manner in which an observer of an audiovisual recording would be expected to pay for the ability to navigate within the audiovisual recording using the DPG data, and the description below of embodiments of the invention is often given in that context.

In one embodiment of the invention, the economic value provided by a Deep Program Guide is reflected in an increased price for apparatus (DPG-enabled apparatus) on or with which one or more computer programs (for convenience, sometimes referred to herein as “DPG software”) embodying the Deep Program Guide operates. (Additionally or alternatively, the economic value provided by a Deep Program Guide may be reflected by an increased inducement to purchase the DPG-enabled apparatus.) If a single entity produces both the DPG-enabled apparatus and the DPG software, then that entity captures all of the economic value provided by the Deep Program Guide. If the entity that produces the DPG software is different from the entity that produces the DPG-enabled apparatus, then the economic value provided by the Deep Program Guide can—and typically will—be shared by those entities. For example, the entity who produces the DPG-enabled apparatus gains benefit of the increased price for (or inducement to purchase) the apparatus, and can pass some of that value on, in the form of a royalty payment, to the entity that produces the DPG software. It is anticipated that this embodiment of the invention can be particularly appropriate when the invention is implemented so that DPG data is created automatically, either at the audiovisual recording display location or at a remote location, since there is no entity with an economic investment in the creation of the DPG data other than the producer(s) of the DPG-enabled apparatus and the DPG software.

In another embodiment of the invention, the economic value provided by a Deep Program Guide is reflected in the price of a subscription provided by a DPG data provider that enables access to one or more sets of DPG data for a specified period of time (which period of time may be unlimited). The DPG data provider may publish DPG data that can be obtained via a communications network (as described above) or by delivery via the mail or a delivery service. (Additionally or alternatively, in a manner similar to that described with respect to the embodiment immediately above, the economic value provided by a Deep Program Guide may be reflected by the inducement the subscription provides to buy DPG-enabled apparatus that can make use of the DPG data.) The DPG data provider could be an entity that produces the DPG software, an entity that produces the DPG-enabled apparatus, an entity that produces both, or an entity that produces neither. Depending on which of the foregoing describes a particular situation, subscription fees can be shared among the producer of the DPG software, producer of the DPG-enabled apparatus, and the DPG data provider.

In yet another embodiment of the invention, the economic value provided by a Deep Program Guide can be realized by providing associated commerce opportunities. A GUI can be used to facilitate this. For example, DPG data can include information regarding items for sale. As the audiovisual recording is displayed, the current state of playback (i.e., time position or frame number) is monitored and, at a specified time, the GUI presents a particular commerce dialog box or an advertisement (which can lead to a commerce dialog box). For example, during the display of a football game, a commerce dialog box linking to fan gear for sale or ticket sales could be displayed after a touchdown, or at some other point specified by the DPG data. Advertisers can be charged for the display of GUI elements that enable link to a commerce opportunity. In particular, a GUI can be implemented so that a commerce opportunity is presented based on the content being displayed. For example, when the audiovisual content is a football game, as a summary of plays including a particular player is displayed, a dialog box or other GUI element can be displayed that enables purchase of merchandise related to that player (e.g., jersey, football cards, etc.).

In still another embodiment of the invention, the economic value provided by a Deep Program Guide is reflected in fees paid for advertising during display of an audiovisual recording. This can be facilitated by use of a GUI, as described further below. Advertisements can be video, audio, text and/or graphics, and can be part of the audiovisual content or separate.

For example, placement (e.g., location on the display screen, location in a particular menu display) and/or frequency of display of an advertisement can be linked to compensation from the advertiser. A GUI according to the invention can enable flexibility in placement of advertisements during an audiovisual recording display. For instance, advertisements can be displayed within a navigational menu display or in an OSD menu, and can be located anywhere therein. A GUI can include a thumbnail that can be selected to enable viewing of an advertisement. In a particular part of the GUI allotted for advertisements (e.g., a particular location of a particular menu), the display of advertisements can be rotated, which can enable targeted advertisement (and, thus, greater revenue possibilities for owner of the audiovisual content). Display of an advertisement can be linked to commerce functionality: for example, display of an advertisement may result in the presentation of a GUI element that enables purchase of an item advertised. The display of advertisements can be based on usage statistics and/or user feedback, e.g., targeted advertisements can be provided to particular audiovisual content observers. Among other ways of monitoring the display of content, the frequency of advertisement display can be monitored by monitoring the display of advertisements in menus of a GUI.

Or, for example, advertisers may also pay for the opportunity to present “opt-in-advertising,” which requires that an observer of an audiovisual recording allow the display of one or more advertisements (the invention can be implemented so that displaying the advertisement(s) in their entirety is required) as a condition of gaining access to use of particular DPG data, e.g., part(s) of the audiovisual recording (such as one or more summaries) and/or related auxiliary content (such as statistics regarding an aspect of a sporting event that is the subject of the audiovisual recording. One or more advertisers may pay the producer of DPG software, the producer of DPG-enabled apparatus, and/or DPG data provider(s) for the right to include their advertisement(s) among those that must be displayed in order to gain access to use of DPG data. An advertisement can also be included among a group of advertisements from which one or more, but not necessarily all, advertisements must be selected in order to gain access to use of DPG data; the payment by an advertiser in this case would generally be expected to be less than that if the advertisement must be displayed. The requirement(s) for displaying advertisement(s) to gain access to use of DPG data can be specified as part of DRM metadata of the DPG data. A GUI can be implemented to enable opt-in advertising. For example, a GUI can display a thumbnail (representative image) in a navigational menu that can be activated to view opt-in advertising. The menu choices 503 and 504 shown in FIGS. 5A, 5B and 5C, discussed above, are examples of such thumbnails that can be selected to view opt-in advertising. The viewing of opt-in advertisements can be monitored in a manner similar to that described below with respect to monitoring activation of a GUI element for use in enforcing a DRM restriction. Data regarding the DRM rules associated with an opt-in advertisement can be linked to data specifying the GUI to enable this functionality. For example, a textual description of the DRM rules and a visual image to use as a thumbnail to enable selection of the advertisement for display can be specified in the DRM data and a reference to such DRM data included in the data specifying the GUI.

Another way in which opt-in advertising (or other advertising) can be integrated into a GUI is by causing display of an advertisement from the audiovisual content in a navigational menu or in the OSD menu at a different time during playback than that at which the advertisement originally occurred. Indices provided as part of the DPG data enable the advertisement (or an image from the advertisement) to be extracted from the audiovisual recording for such display and data for specifying the GUI identifies where and when the advertisement is to be displayed. When the GUI is used with display of an audiovisual recording that is different from the recording used to produce the indices, such functionality is only possible through an a precise alignment of the two recordings, such as can be produced using a method as described in the above-described U.S. patent application Ser. No. 11/268,752.

### XI. Digital Rights Management Using DPG Data

A Deep Program Guide can be implemented to make use of various forms of digital rights management (DRM) to allow control over the conditions under which access to an audiovisual recording and/or associated content, or part(s) thereof, is allowed. There are a number of existing DRM mechanisms and a DPG system can make use of those mechanisms. Additionally, the invention can make use of DPG data to provide new DRM capabilities.

For example, a DRM scheme can initially control whether DPG data is provided to an audiovisual recording display location or not by determining whether an audiovisual recording at the audiovisual recording display location is a version of an audiovisual recording for which DPG data is available. If information identifying the audiovisual recording (e.g., date, time and channel of acquisition, duration), this information can be used. However, if such information is not provided, such control can be effected using the alignment data discussed in more detail above. Not only can the alignment signatures discussed above be used to align two versions of an audiovisual recording, the alignment signatures can be used to determine whether the two recordings are, in fact, of the same content, as described in the above-referenced U.S. patent application Ser. No. 11/268,752. By comparing the alignment signature of an audiovisual recording at an audiovisual recording display location to the alignment signature associated with particular DPG data (i.e., the alignment signature produced from the audiovisual recording used to create the DPG data), it can be determined whether the DPG data is applicable to that audiovisual recording: if the alignment signatures match, the DPG data is applicable for use with that audiovisual recording; if not, it isn't. More generally, such matching of audiovisual recordings can be used to identify whether an audiovisual recording is of specified content and, then, if it is, control access to the audiovisual recording in accordance with one or more DRM rules; if it is not, access can be disallowed.

Once it has been determined that DPG data can be provided to an audiovisual recording display location for use with an audiovisual recording at that location, the segment definition indices of the DPG data can be used to effect further DRM by enabling control of access (e.g., display, modification of segment definition indices) to parts of the audiovisual recording as defined by the segment definition indices. For example, a DRM scheme can allow the segments defined by certain segment definition indices to be displayed while prohibiting display of other segments defined by other segment definition indices. Such a DRM scheme can be used, for instance, to allow a free preview of an audiovisual recording for which a payment must be made to display the audiovisual recording in its entirety. A GUI menu system can present a navigational menu that allows access to one or more segments that constitute a preview summary of the content of the entire audiovisual recording. Access to the preview summary is free to all who have the audiovisual recording. In order to display the entire audiovisual recording, the DRM rule(s) proof of payment must be provided. Upon selection of a GUI element representing the entire audiovisual content, a dialog box can be presented that includes a display of relevant access rules and what constitutes acceptable credentials (e.g., an acceptable validation signature), which can be contained within the DRM metadata section of the DPG data. A data entry box can also be presented that enables entry of required information, such as a security key or password. If payment is made and the security key or password provided, that information can be provided via the data entry box and compared to the required validation signature to determine whether access to the entire audiovisual recording can be made accessible through the DPG menu system.

DPG data can also be used in providing DRM with respect to multiple displays of the same audiovisual recording. Previously, it has only been possible to control the number of broadcasts of audiovisual content. An ongoing problem in digital rights management has been how to fully control access to audiovisual content which has been recorded from broadcast. Since, as discussed above, two recordings of the same audiovisual content may be represented by two different sets of audiovisual data, it has been difficult or impossible to identify with confidence that a particular audiovisual recording is of particular broadcast audiovisual content, thus hindering efforts to control the display of recordings of broadcast audiovisual content. However, the alignment signatures that can be included as part of DPG data can enable matching of the content different audiovisual recordings with extremely high accuracy, thus enabling state-of-the-art security mechanisms for DRM to be applied appropriately to recordings of broadcast audiovisual content. Thus, DPG data can be used to enable DRM that controls whether and how often a recording of broadcast audiovisual content is displayed. A DPG may implement a menu system that counts how many times an audiovisual recording has been displayed (e.g., monitor the number of activations of a GUI element that causes display of the audiovisual recording) and disable further display if the count exceeds a pre-set limit, until payment for further viewings of the audiovisual recording has been proven, using a mechanism similar to that described above. Such a DRM system can allow simulated broadcasting on hard-drive-based recording devices, although it would not be limited to such devices. To protect the rights of content owners, apparatus for playback and recording of audiovisual content may be required to implement DRM, using DPG data as described above, on any audiovisual recording. Further, as discussed above, the segment definition indices of DPG data can enable precise (e.g., frame-accurate) and flexible control of the display of an audiovisual recording by enabling control of the display of any part of an audiovisual recording and, in particular, a precisely defined part of an audiovisual recording.

DPG data can also be used in implementing opt-in advertising (discussed above). An observer of an audiovisual recording can be required to navigate to an advertisement (i.e., cause display of the advertisement) in order to gain access to parts of the DPG user interface, e.g., to enable display of parts of the audiovisual recording (such as particular summaries) and/or related auxiliary content (such as statistics regarding an aspect of a sporting event that is the subject of the audiovisual recording). For example, a GUI can display a thumbnail (representative image) in a menu that can be activated to view opt-in advertising. (The invention can also be implemented so that activation of the thumbnail enables viewing of an advertisement without any association with a DRM restriction, i.e., an advertisement that is not an opt-in advertisement.) The menu choices 503 and 504 shown in FIGS. 5A, 5B and 5C, discussed above, are examples of such thumbnails that can be selected to view opt-in advertising. An advertiser may be charged for display of a thumbnail in a menu of the GUI. Further, the advertiser may be allowed to choose the image to be displayed. The rules for such restricted access can be embedded within the DRM metadata of the DPG data, as discussed above. Aspects of a GUI that enable navigation to opt-in advertisements, including instructions that explain the benefits of doing so, may be specified using both DRM metadata and GUI metadata, and the two may be linked using references within the DPG data. For example, a textual description of the DRM rules and a visual image to use as a thumbnail to enable selection of the advertisement for display can be specified in the DRM data and a reference to such DRM data included in the data specifying the GUI. The viewing of opt-in advertisements can be monitored by monitoring activation of a GUI element. The use of a GUI in effecting opt-in advertising is described in more detail in above-referenced U.S. patent application Ser. No. 11/268,778.

The invention can make use of a GUI to enable or facilitate presentation of DRM interaction to a user by, for example, enabling presentation of appropriate menu displays and dialog boxes, and monitoring the display of menu and GUI element displays. For example, when a user attempts to access some DRM-protected functionality, the user can be presented with a dialog box that describes the DRM requirements that must be met, such as, for example, accepting a contract agreement, fulfilling a purchase requirement, or viewing a specified part of the audiovisual content or a specified advertisement. The GUI can present additional GUI elements that enable a user to provide input to satisfy the DRM requirements, such as a button to accept an agreement, a data entry box to enter a password or security key, or a “clickable” image representing a part of the audiovisual content or an advertisement to begin display of the part of the audiovisual content or advertisement. Such GUI elements can be used, for example, as described above with respect to presenting a free preview of audiovisual content that can be displayed in its entirety upon meeting specified DRM restrictions. Or, for example, a GUI can be implemented to monitor the number of activations of a GUI element that causes display of an audiovisual recording or a part of an audiovisual recording. Further display can be disabled once a specified number of activations (i.e., a specified number of displays) has occurred, unless a specified condition (e.g., a payment) is satisfied.

### XII. Exemplary Application: DPG for a Sporting Event

As indicated above, a DPG can advantageously be used to enable navigation within an audiovisual recording of a sporting event. Below, to illustrate principles of the invention described above, an exemplary implementation of the invention is described that enables navigation within a recording of a football game. A similar implementation can be used to enable navigation within recordings of other types of sporting events.

A particular football game is recorded from television onto a DPG-enabled apparatus. The DPG-enabled apparatus can be, for example, a hard-drive-based video recorder (e.g., PVR or DVD recorder) or set-top box. Further, the DPG-enabled apparatus can be adapted to enable communication (which can be wired or wireless) via a computer network such as the Internet. The Internet connection can enable the DPG-enabled apparatus to communicate with a DPG data service provider (e.g., DPG data provision web site) to request DPG data and receive requested DPG data. The request from the DPG-enabled apparatus includes data that enables the DPG data service provider to identify the recording for which DPG data is requested. For example, the request from the DPG-enabled apparatus can include the time of recording and the broadcasting entity, such as one of the major broadcasting networks) from which the recording was made. Additionally or alternatively, the DPG-enabled apparatus can provide an alignment signature for the recording, which can be used as described above to identify the recording. Use of the alignment signature to identify the recording may be necessary even when the time and broadcasting entity of the recording are provided. This may, in particular, be the case when recording a broadcast of a football game, since different games may have been broadcast to different geographic regions at the same time by the same broadcasting entity. The DPG-enabled apparatus can be implemented (e.g., can operate in accordance with one or more computer programs) to automatically request DPG data for an audiovisual recording after the recording is acquired. Authorization to receive DPG data for a recording can be established in a variety of ways. For example, the DPG data service provider may offer a subscription service that provides DPG data for a certain number or type of audiovisual recording. If the DPG-enabled apparatus has already been authorized to receive DPG data for the football game recording, the DPG-enabled apparatus can have requested and received the DPG data before the football game recording is displayed. DPG software can operate on the DPG-enabled apparatus so that when playback of the recording of the football game is requested, the DPG data automatically causes a menu display to be produced that enables navigation within the recording in using the DPG data.

FIGS. 5A through 5D illustrate a set of menu displays, according to an embodiment of the invention, that enable navigation of a recording of a football game in accordance with the invention. FIG. 5A illustrates an introductory menu display 500 that includes a menu choice 501 that enables selection of the entire recording of the football game for display, and a menu choice 502 that enables selection of a part of the recording of the football game for display. FIG. 5A also includes menu choices 503 and 504 that enable selection of opt-in advertising.

FIG. 5B illustrates a menu 510 that is displayed in response to selection of menu choice 502 of the menu 500 that indicates a desire to watch a part of the audiovisual recording. The menu 510 includes four menu choices 511, 512, 513 and 514, each of which identify parts of the recording of the football game of a particular type that can be selected for display. The menu choice 511 enables display of parts of the recording of the football game that include a particular player or players. The menu choice 512 enables display of parts of the recording of the football game that include a particular type of play. The menu choice 513 enables display of parts of the recording of the football game that include a scoring play. The menu choice 514 enables display of parts of the recording of the football game that include all game action from a particular quarter of the game.

FIG. 5C illustrates a menu 520 that is displayed in response to selection of the menu choice 512 of the menu 510. The menu 520 includes five menu choices 521, 522, 523, 524 and 525, each of which identify one or more parts of the recording of the football game that will be displayed upon selection of that menu choice. In accordance with the menu choice 512, each of the menu choices 521, 522, 523, 524 and 525 enable display of parts of the recording of the football game that include a particular type of play: selection of menu choice 521, 522, 523, 524 or 525 causes display of parts of the recording including the occurrence of a touchdown, interception, fumble, sack, or field goal, respectively.

FIG. 5D illustrates a menu 530 that is displayed in response to selection of the menu choice 511 of the menu 510. The menu 520 includes six menu choices 531, 532, 533, 534, 535 and 536, each of which identify one or more parts of the recording of the football game that will be displayed upon selection of that menu choice. In accordance with the menu choice 511, each of the menu choices 531, 532, 533, 534, 535 and 536 enable display of parts of the recording of the football game that include a particular player or players: selection of menu choice 521, 522, 523, 524, 525 or 526 causes display of parts of the recording that include, respectively, players named K. Colbert, J. Delhomme, N. Goings, B. Hoover, M. Muhammad and R. Proehl.

The DPG data can include DRM restrictions on the viewing of the recording of the football game. For example, rather than the menu display 500 illustrated in FIG. 5A, DRM and GUI metadata of the DPG data can produce a menu display including menu choices that provide restricted and unrestricted options. For example, one menu choice can enable unrestricted viewing of a preview of the recording, while another can enable unrestricted viewing of the entire recording at one time. Other menu choices may offer enhanced or unrestricted viewing of the recording that is conditioned on satisfaction of one or more conditions specified by DRM rules.

For example, another menu choice may enable presentation of one or more additional menus that include menu choices that produce summaries of the recording or that provide auxiliary content (e.g., any of a variety of statistics regarding the teams and/or players involved in the game). However, access to the summaries and auxiliary content may be conditioned on displaying one or more particular advertisements in their entirety. Summaries that can be made available for display if the advertisement(s) are displayed can include those illustrated above in FIGS. 5B through 5D. Each summary is specified in the DPG data as a set of segment definition indices. Before display of a summary, the segment definition indices for that summary are adjusted based on an alignment of the recording as described above, thus ensuring that appropriate summaries (i.e., including all of the intended content an no unintended content) are produced regardless of the effect of recording conditions on the production of the recording.

Or, for example, another menu choice may enable unlimited viewing (i.e., viewing any number of times and at any time) and archival of the recording if appropriate payment is received. Any method for making payments via a communications network can be used, a variety of which are known. Upon payment, a pass-key can be provided which can be entered using an appropriate part of the DPG user interface and matched against credentials specified within the DRM metadata of the DPG data. The credentials may use a security algorithm that involves a unique device identifier in combination with the pass-key to guarantee that the pass-key is only valid on this particular DPG-enabled apparatus.

Various embodiments of the invention have been described. The descriptions are intended to be illustrative, not limiting. Thus, it will be apparent to one skilled in the art that certain modifications may be made to the invention as described herein without departing from the scope of the claims set out below.

We claim:

1. A data storage medium or media encoded with one or more data structures for use in indexing a first audiovisual recording including one or more shows to enable navigation within a show, comprising:
one or more segment definition indices that identify one or more segments of the audiovisual recording, wherein at least one segment is a subset of, but not coincident with, a show of the audiovisual recording, and wherein the one or more segment definition indices were produced using a second audiovisual recording that is different from the first audiovisual recording; and
graphical user interface metadata for use in producing a graphical user interface that enables navigation of the audiovisual recording using the segment definition indices, wherein the content of the graphical user interface metadata depends on the segment identification indices and/or content of the audiovisual recording.

2. A data storage medium or media as in claim 1, wherein the graphical user interface metadata comprises data representing one or more characteristics of one or more graphical user interface elements.

3. A data storage medium or media as in claim 2, wherein data representing one or more characteristics of a graphical user interface element comprises:
data identifying the graphical user interface element;
data identifying the location of the graphical user interface element in a graphical user interface display;
data identifying an action associated with selection of the graphical user interface element; and
data specifying the appearance of the graphical user interface element.

4. A data storage medium or media as in claim 1, wherein the graphical user interface metadata comprises an identification of a graphical user interface template.

5. A data storage medium or media as in claim 1, wherein the graphical user interface metadata comprises a graphical user interface template that can be identified based on a determination of a type of the audiovisual recording.

6. A data storage medium or media as in claim 5, wherein:
the audiovisual recording is produced from a broadcast of audiovisual content; and
the type of the audiovisual recording can be ascertained from broadcast information.

7. A data storage medium or media as in claim 5, wherein the type of the audiovisual recording can be ascertained from an electronic program guide.

8. A data storage medium or media as in claim 1, wherein the content of the graphical user interface metadata depends on the segment identification indices.

9. A data storage medium or media as in claim 1, wherein the content of the graphical user interface metadata depends on the content of the audiovisual recording.

10. A data storage medium or media encoded with one or more computer programs and/or data structures for use in indexing an audiovisual recording including one or more shows to enable navigation within a show, comprising:
computer code for using one or more segment definition indices to navigate within a show, the one or more segment definition indices identifying one or more segments of the audiovisual recording, wherein at least one segment is a subset of, but not coincident with, a show of the audiovisual recording; and
computer code for use in producing a graphical user interface that enables navigation of the audiovisual recording using the segment definition indices, wherein the content of the graphical user interface depends on the segment identification indices and/or the audiovisual recording.

11. A data storage medium or media as in claim 10, further comprising computer code for receiving one or more graphical user interface templates for use in producing the graphical user interface.

12. A data storage medium or media as in claim 10, further comprising computer code for identifying a graphical user interface template based on a determination of a type of the audiovisual recording.

13. A data storage medium or media as in claim 12, further comprising computer code for ascertaining the type of the audiovisual recording from broadcast information.

14. A data storage medium or media as in claim 12, further comprising computer code for ascertaining the type of the audiovisual recording from an electronic program guide.

15. A data storage medium or media as in claim 10, further comprising computer code for receiving data representing the segment definition indices and graphical user interface metadata for use in producing the graphical user interface.

16. A data storage medium or media as in claim 15, wherein the graphical user interface metadata comprises an identification of a graphical user interface template.

17. A data storage medium or media as in claim 15, wherein the graphical user interface metadata comprises data representing one or more characteristics of one or more graphical user interface elements.

18. A data storage medium or media encoded with one or more computer programs and/or data structures for use in archiving data used in indexing an audiovisual recording including one or more shows to enable navigation within a show, comprising:
computer code for receiving, via a communications network, one or more segment definition indices identifying one or more segments of the audiovisual recording, wherein at least one segment is a subset of, but not coincident with, a show of the audiovisual recording; and
computer code for archiving the segment definition indices on a portable data storage apparatus.

19. A data storage medium or media as in claim 18, wherein the computer code for archiving archives in a format compatible with the portable data storage apparatus.

20. A data storage medium or media as in claim 19, wherein the portable data storage apparatus comprises one or more DVDs.

21. A data storage medium or media as in claim 18, further comprising computer code for archiving the audiovisual recording on the portable data storage apparatus.

22. A data storage medium or media encoded with one or more computer programs and/or data structures for use in archiving data used in indexing an audiovisual recording including one or more shows to enable navigation within a show, comprising:
computer code for archiving one or more segment definition indices on a portable data storage apparatus, wherein the one or more segment definition indices identify one or more segments of the audiovisual recording, and at least one segment is a subset of, but not coincident with, a show of the audiovisual recording; and
computer code for archiving on the portable data storage apparatus graphical user interface metadata for use in producing a graphical user interface that enables navigation of the audiovisual recording using the segment definition indices.

23. A data storage medium or media as in claim 22, wherein the computer code for archiving archives in a format compatible with the portable data storage apparatus.

24. A data storage medium or media as in claim 23, wherein the portable data storage apparatus comprises one or more DVDs.

25. A data storage medium or media as in claim 22, further comprising computer code for archiving the audiovisual recording on the portable data storage apparatus.

26. A data storage medium or media encoded with one or more computer programs and/or data structures for use in archiving data used in indexing an audiovisual recording including one or more shows to enable navigation within a show, comprising:
computer code for using one or more segment definition indices that identify one or more segments of the audiovisual recording, wherein at least one segment is a subset of, but not coincident with, a show of the audiovisual recording, to identify one or more parts of the show
computer code for archiving the one or more parts of the show on portable data storage apparatus.

27. A data storage medium or media as in claim 26, wherein the computer code for archiving archives in a format compatible with the portable data storage apparatus.

28. A data storage medium or media as in claim 27, wherein the portable data storage apparatus comprises one or more DVDs.

29. A data storage medium or media encoded with one or more data structures for use in indexing an audiovisual recording including one or more shows to enable navigation within a show, comprising:
one or more segment definition indices that identify one or more segments of the audiovisual recording, wherein at least one segment is a subset of, but not coincident with, a show of the audiovisual recording; and
digital rights management metadata for use in controlling access to the audiovisual recording and/or auxiliary content that may be displayed in conjunction with the audiovisual recording, wherein the digital rights management metadata controls access to at least one summary including one or more segments that are a subset of, but not coincident with, a show of the audiovisual recording.

30. A data storage medium or media as in claim 29, wherein the digital rights management metadata specifies one or more advertisements that must be displayed before display of a summary or specified auxiliary content is allowed.

31. A data storage medium or media encoded with one or more computer programs and/or data structures for use in indexing an audiovisual recording including one or more shows to enable navigation within a show, comprising:
computer code for evaluating the content of the audiovisual recording to identify one or more segment definition indices that identify one or more segments of the audiovisual recording, wherein at least one segment is a subset of, but not coincident with, a show of the audiovisual recording, and wherein the at least one segment definition indices correspond to locations in the audiovisual recording other than locations corresponding to a transition or film edit;
computer code for receiving an input from an observer; and
computer code for navigating within the show of the audiovisual recording in response to the input and based on the one or more segment identification indices.

32. A data storage medium or media encoded with one or more computer programs and/or data structures for use in indexing an audiovisual recording including one or more shows to enable navigation within a show, comprising:
computer code for receiving input from an observer during display of the audiovisual recording; and
computer code for identifying, in response to the input, one or more segment definition indices that identify one or more segments of the audiovisual recording, wherein at least one segment is a subset of, but not coincident with, a show of the audiovisual recording; and
computer code for enabling navigation within the show of the audiovisual recording based on the one or more segment identification indices.

33. A data storage medium or media as in claim 32, further comprising:
computer code for receiving a second input from the observer during display of the audiovisual recording; and
computer code for modifying, in response to the second input, one or more segment definition indices that identify one or more segments of the audiovisual recording, wherein at least one segment is a subset of, but not coincident with, a show of the audiovisual recording.

34. A data storage medium or media encoded with one or more computer programs and/or data structures for use in indexing an audiovisual recording including one or more shows to enable navigation within a show, comprising:
computer code for receiving input from an observer during display of the audiovisual recording; and
computer code for modifying, in response to the input, one or more segment definition indices that identify one or more segments of the audiovisual recording, wherein at least one segment is a subset of, but not coincident with, a show of the audiovisual recording; and
computer code for enabling navigation within the show of the audiovisual recording based on the one or more segment identification indices.
